(19) United States
(12) Patent Application Publication
(10) Pub. No.: US 2026/0247506 A1
(43) Pub. Date: Aug. 20, 2026

(54) APPARATUS AND METHOD FOR DETERMINING ELECTRICAL SETTINGS FOR LIGHT EMITTING TAPE

(71) Applicant: ARKALUMEN INC., Ottawa (CA)

(72) Inventors: Sean MacLean MURRAY, Kingston (CA); Bradley REID, Ottawa (CA); Ayman YAGHI, Ottawa (CA)

(73) Assignee: ARKALUMEN INC., Ottawa (CA)

(21) Appl. No.: 19/058,943

(22) Filed: Feb. 20, 2025

(51) Int. Cl. H05B 45/14; H05B 45/345

(52) U.S. Cl. CPC H05B 45/14; H05B 45/345

(57) ABSTRACT

The present disclosure provides a lighting apparatus comprising an LED tape and a control apparatus. The LED tape includes a plurality of connected segments, each of the segments comprising an LED path having at least one LED coupled in parallel with LEDs in other of the segments. A first set of the segments further comprise a reference path comprising a reference element, such as a resistor, coupled in parallel with reference elements in other of the segments of the first set. The control apparatus is operable to determine an indication of a number of the segments in the LED tape using the reference elements coupled in parallel within the first set of the segments. The control apparatus is further operable to determine an electrical setting, such as a maximum current, for the LEDs within the segments of the LED tape based on the indication of the number of segments.

### FIELD OF THE INVENTION

The invention relates generally to light emitting arrays and lighting controls and, more particularly, to lighting apparatus, control apparatus, LED tape, and method for determining electrical settings of LED tape.

### BACKGROUND OF THE INVENTION

Use of light emitting diode (LED) modules and controllers have increased drastically due to technological advances in LED light output and efficiency in the last two decades. More recently, solutions have been developed to provide increased control of multiple LEDs with longer LED lifespan and a reduced cost for LED manufacture. However, many problems exist in the market. Manufacturers of lighting apparatus will typically know a maximum current that an installed LED module should operate at since they either know the specifications of the LED modules used or know the number of parallel LED paths in their LED modules in the case that they cut their LED module to a desired length and the maximum current per parallel LED path. The knowledge of the maximum current for the installed LED modules allows the manufacturer to use a constant current driver in the lighting apparatus that may be limited to a desired current for the lighting apparatus or may be programmed to the desired current. The use of constant current drivers can enable the lighting apparatus to operate with a high energy efficiency and, in some embodiments, be dimmed using Constant Current Reduction (CCR), hence limiting flicker that other dimming technology such as Pulse Width Modulation (PWM) could cause.

LED tape typically comprises a large number of LED segments, each LED segment comprising an LED path in parallel with the LED paths in the other LED segments. Further, LED tape is typically cuttable with potentially an unknown number of LED segments in the LED tape during use, and therefore an unknown number of parallel LED paths in the LED tape during use. This uncertainty of the number of parallel LED paths in the LED tape during use makes using a constant current driver often impractical, especially if the LED tape is being cut to a desired length by an end-user or installer. The end-user or installer may not know a) how to calculate the total number of parallel LED paths in the LED tape, b) how to calculate the maximum current that should be applied to the LED tape due to the number of parallel LED paths in the LED tape, and/or c) how to program a constant current driver to an appropriate maximum current for the LED tape.

Therefore, most current lighting apparatus that use cuttable LED tape are powered by constant voltage drivers and the LED tape uses resistors in each LED path to match the LED forward voltage of each LED path to the constant voltage output from the driver. This architecture allows an end user or installer to cut the LED tape to their desired length and not need to adjust the driver. The constant voltage driver will provide the constant voltage required for the LED tape length in use, assuming the driver has sufficient power for the load. Unfortunately, this architecture is not energy efficient as significant power can be dissipated in the resistors. Further, to dim the light, the constant voltage driver must typically use PWM which applies a flicker to the light which can be deemed negative.

As such, there is a need for solutions in the lighting space that will mitigate at least one of the above problems.

### SUMMARY OF THE INVENTION

According to a first broad aspect, the present invention is a lighting apparatus comprising an LED tape and a control apparatus. The LED tape comprises a plurality of connected segments, each of the segments comprising an LED path comprising at least one LED coupled in parallel with LEDs in other of the segments. Each of a first set of the segments further comprise a reference path comprising a reference element coupled in parallel with reference elements in other of the segments of the first set. The control apparatus is operable to determine an indication of a number of the segments in the LED tape using the reference elements coupled in parallel within the first set of the segments.

In some embodiments, the control apparatus is operable to determine an electrical setting for the LEDs within the segments of the LED tape based on the indication of the number of segments. The electrical setting to be applied to the LEDs may comprise a maximum current to be applied to the LEDs within the segments of the LED tape based on the indication of the number of segments of the LED tape. To determine the electrical setting for the LEDs within the segments of the LED tape, the control apparatus may be operable to access a database comprising a plurality of records, each record indicating a specific maximum current to be applied to the LEDs within the segments of the LED tape based on the indication of the number of segments of the LED tape. In some embodiments, the control apparatus is incorporated within an LED driver that is operable to apply a current less than or equal to the maximum current to be applied to the LEDs within the segments of the LED tape.

In some embodiments, each of the segments comprises a first LED path comprising at least one first LED coupled in parallel with first LEDs in other of the segments and a second LED path comprising at least one second LED coupled in parallel with second LEDs in other of the segments. In this case, the electrical setting to be applied to the LEDs may comprise a first maximum current to be applied to the first LEDs within the segments of the LED tape based on the indication of the number of segments of the LED tape and a second maximum current to be applied to the second LEDs within the segments of the LED tape based on the indication of the number of segments of the LED tape.

In some embodiments, the LED tape is cuttable to a plurality of different numbers of segments. In some embodiments, to determine the indication of the number of segments in the LED tape, the control apparatus is operable to determine an indication of a number of the reference elements coupled in parallel within the first set of the segments of the LED tape. In some cases, the first set of the segments comprises all of the segments of the LED tape; whereby the indication of the number of reference elements in parallel within the LED tape is the indication of the number of segments in the LED tape. In other cases, the first set of the segments comprises a plurality of reference segments spread out at predetermined intervals along the length of the LED tape; whereby the indication of the number of reference elements in parallel within the LED tape is an indication of a number of reference segments in the LED tape and, as the plurality of reference segments are spread out at the predetermined intervals along the length of the LED tape, the indication of the number of reference elements in parallel within the LED tape is further the indication of the number of segments in the LED tape.

In embodiments of the present invention, the reference element within the reference path of each segment of the first set may comprise a resistor. To determine the indication of the number of segments in the LED tape, the control apparatus is operable to determine an indication of a number of the resistors coupled in parallel within the first set of the segments of the LED tape. In some cases, to determine the indication of the number of resistors coupled in parallel within the first set of the segments, the control apparatus may be operable to apply a predetermined voltage to the resistors coupled in parallel within the first set of the segments and to detect an indication of a resulting current flowing through the resistors coupled in parallel within the first set of the segments. In other cases, to determine the indication of the number of resistors coupled in parallel within the first set of the segments, the control apparatus is operable to apply a first predetermined voltage to the resistors coupled in parallel within the first set of the segments and to detect a first indication of a resulting current flowing through the resistors coupled in parallel within the first set of the segments; and, if the first indication of the resulting current flowing through the resistors is greater than a first limit, to apply a second predetermined voltage to the resistors coupled in parallel within the first set of the segments and to detect a second indication of a resulting current flowing through the resistors coupled in parallel within the first set of the segments. In this case, the second predetermined voltage is less than the first predetermined voltage.

In other cases, to determine the indication of the number of resistors coupled in parallel within the first set of the segments, the control apparatus is operable to apply a predetermined current to the resistors coupled in parallel within the first set of the segments and to detect an indication of a resulting voltage across the resistors coupled in parallel within the first set of the segments. In other cases, to determine the indication of the number of resistors coupled in parallel within the first set of the segments, the control apparatus is operable to apply a first predetermined current to the resistors coupled in parallel within the first set of the segments and to detect a first indication of a resulting voltage across the resistors coupled in parallel within the first set of the segments; and, if the first indication of the resulting voltage across the resistors is less than a first limit, to apply a second predetermined current to the resistors coupled in parallel within the first set of the segments and to detect a second indication of a resulting voltage across the resistors. In this case, the second predetermined current is greater than the first predetermined current.

According to a second broad aspect, the present invention is a control apparatus operable to connect to an LED tape, the control apparatus comprising an interface and a controller. The LED tape comprises a plurality of connected segments, each of the segments comprising an LED path comprising at least one LED coupled in parallel with LEDs in other of the segments. Each of a first set of the segments further comprise a reference path comprising a reference element coupled in parallel with reference elements in other of the segments of the first set. The interface is operable to connect to the reference paths in each of the first set of the segments of the LED tape. The controller is operable to determine an indication of a number of the segments in the LED tape using the reference elements coupled in parallel within the first set of the segments.

In some embodiments, the controller is operable to determine an electrical setting for the LEDs within the segments of the LED tape based on the indication of the number of segments. The electrical setting to be applied to the LEDs may comprise a maximum current to be applied to the LEDs within the segments of the LED tape based on the indication of the number of segments of the LED tape. To determine the electrical setting for the LEDs within the segments of the LED tape, the controller may be operable to access a database comprising a plurality of records, each record indicating a specific maximum current to be applied to the LEDs within the segments of the LED tape based on the indication of the number of segments of the LED tape. In some embodiments, the present invention is an LED driver comprising the control apparatus. In these embodiments, the interface is operable to connect to the LED paths in each of the segments of the LED tape and the LED driver is operable to apply a current less than or equal to the maximum current to be applied to the LED paths within the segments of the LED tape.

In some embodiments, each of the segments in the LED tape comprises a first LED path comprising at least one first LED coupled in parallel with first LEDs in other of the segments and a second LED path comprising at least one second LED coupled in parallel with second LEDs in other of the segments. In this case, the electrical setting to be applied to the LEDs may comprise a first maximum current to be applied to the first LEDs within the segments of the LED tape based on the indication of the number of segments of the LED tape and a second maximum current to be applied to the second LEDs within the segments of the LED tape based on the indication of the number of segments of the LED tape.

In embodiments of the present invention, the reference element within the reference path of each segment of the first set comprises a resistor. To determine the indication of the number of segments in the LED tape, the controller may be operable to determine an indication of a number of the resistors coupled in parallel within the first set of the segments of the LED tape. In some cases, to determine the indication of the number of resistors coupled in parallel within the first set of the segments, the controller is operable to apply a predetermined voltage to the resistors coupled in parallel within the first set of the segments and to detect an indication of a resulting current flowing through the resistors coupled in parallel within the first set of the segments. In other cases, to determine the indication of the number of resistors coupled in parallel within the first set of the segments, the controller is operable to apply a first predetermined voltage to the resistors coupled in parallel within the first set of the segments and to detect a first indication of a resulting current flowing through the resistors coupled in parallel within the first set of the segments; and, if the first indication of the resulting current flowing through the resistors is greater than a first limit, to apply a second predetermined voltage to the resistors coupled in parallel within the first set of the segments and to detect a second indication of a resulting current flowing through the resistors coupled in parallel within the first set of the segments. In this case, the second predetermined voltage is less than the first predetermined voltage.

In some cases, to determine the indication of the number of resistors coupled in parallel within the first set of the segments, the controller is operable to apply a predetermined current to the resistors coupled in parallel within the first set of the segments and to detect an indication of a resulting voltage across the resistors coupled in parallel within the first set of the segments. In other cases, to determine the indication of the number of resistors coupled in parallel within the first set of the segments, the controller is operable to apply a first predetermined current to the resistors coupled in parallel within the first set of the segments and to detect a first indication of a resulting voltage across the resistors coupled in parallel within the first set of the segments; and, if the first indication of the resulting voltage across the resistors is less than a first limit, to apply a second predetermined current to the resistors coupled in parallel within the first set of the segments and to detect a second indication of a resulting voltage across the resistors. In this case, the second predetermined current is greater than the first predetermined current.

According to a third broad aspect, the present invention is an LED tape comprising a plurality of connected segments. Each of the segments comprises an LED path comprising at least one LED coupled in parallel with LEDs in other of the segments. Each of a first set of the segments further comprise a reference path comprising a reference element coupled in parallel with reference elements in other of the segments of the first set. Whereby, an indication of the number of reference elements coupled in parallel is an indication of the number of the segments in the LED tape.

The LED tape may be cuttable to a plurality of numbers of segments. In some embodiments, the first set of the segments comprises all of the segments of the LED tape. In other embodiments, the first set of the segments comprises a plurality of reference segments spread out at predetermined intervals along the length of the LED tape. In embodiments of the present invention, the reference element within the reference path of each segment of the first set comprises a resistor.

### BRIEF DESCRIPTION OF THE DRAWINGS

A detailed description of embodiments of the invention is provided herein below, by way of example only, with reference to the accompanying drawings, in which:

FIGS. 1A, 1B, 1C and 1D are block diagrams of lighting apparatus according to various embodiments of the present invention;

FIG. 2 is a block diagram of a control apparatus of the lighting apparatus of FIG. 1A according to an embodiment of the present invention;

FIGS. 3A and 3B are circuit diagrams of an LED tape of the lighting apparatus of FIG. 1A according to various embodiments of the present invention;

FIGS. 3C and 3D are circuit diagrams of an LED tape of the lighting apparatus of FIG. 1D according to various embodiments of the present invention;

FIGS. 4A and 4B are flowchart diagrams of steps performed by the control apparatus of the lighting apparatus of FIG. 1A according to embodiments of the present invention; and

FIGS. 5A and 5B are flowchart diagrams of steps performed by the control apparatus of the lighting apparatus of FIG. 1A according to further embodiments of the present invention.

It is to be expressly understood that the description and drawings are only for the purpose of illustration of certain embodiments of the invention and are an aid for understanding. They are not intended to be a definition of the limits of the invention.

### DETAILED DESCRIPTION OF EMBODIMENTS

The following embodiments are merely illustrative and are not intended to be limiting. It will be appreciated that various modifications and/or alterations to the embodiments described herein may be made without departing from the disclosure and any modifications and/or alterations are within the scope of the contemplated disclosure.

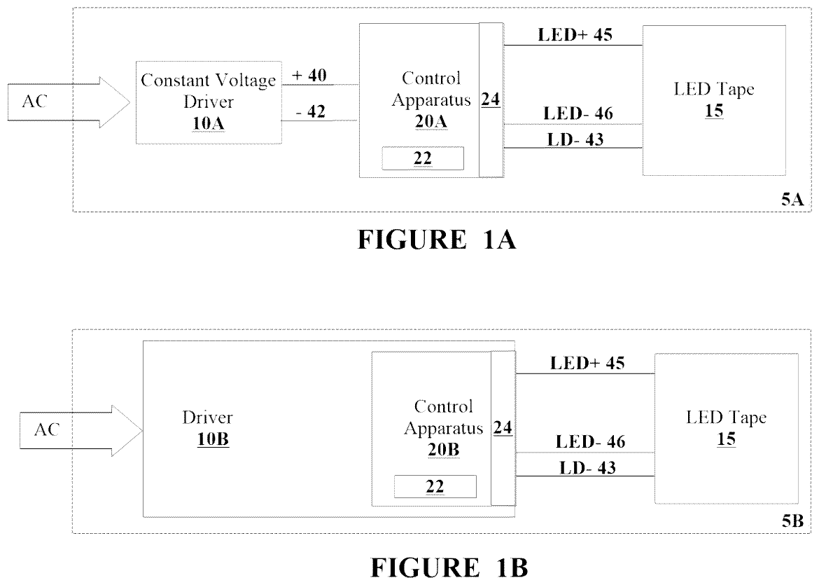

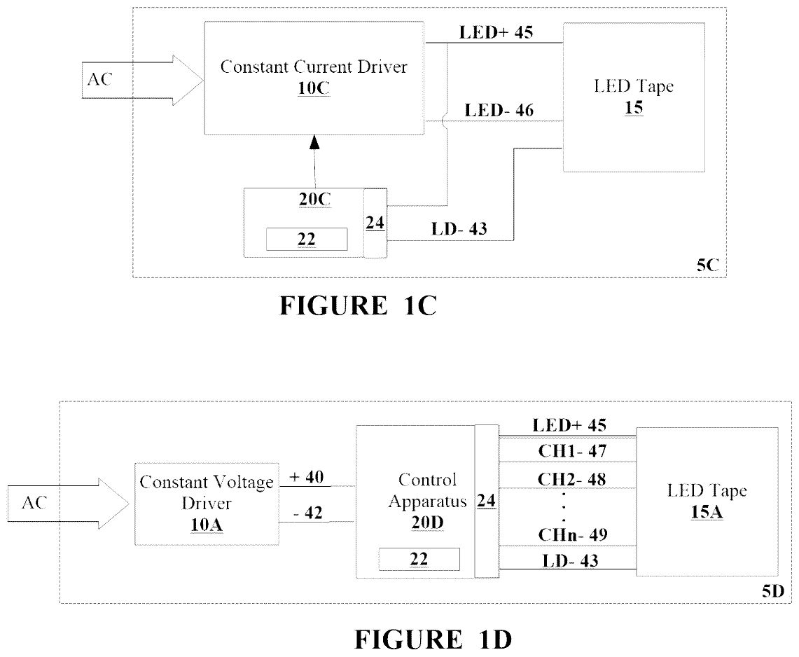

The present invention is directed to embodiments of lighting apparatus in which a control apparatus is implemented to determine an indication of a length of an LED tape and adjust an electrical setting such as a maximum current in response to the indication of the length of the LED tape. The present invention allows for the use of constant current drivers to be used to power the LED tape while maintaining simplicity with the installer of the LED tape, even if the installer cuts the LED tape to a new shorter length than was originally provided to the installer and the installer is not able to adjust the current output of the constant current driver to accommodate this new shorter length of the LED tape. Various embodiments of the present invention are described with reference to FIGS. 1A-1D, 2 and 3A-3D, though these implementations should not limit the scope of the present invention.

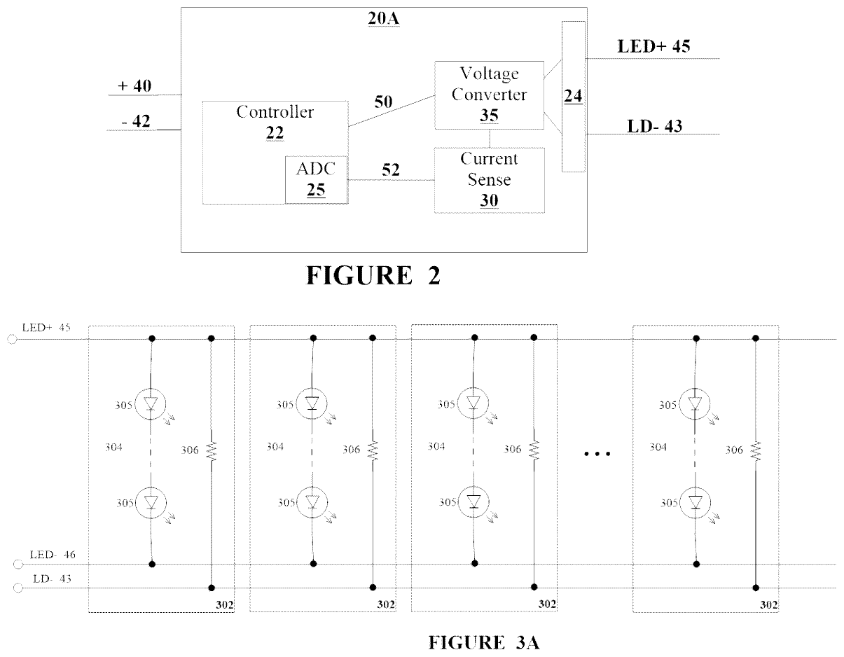

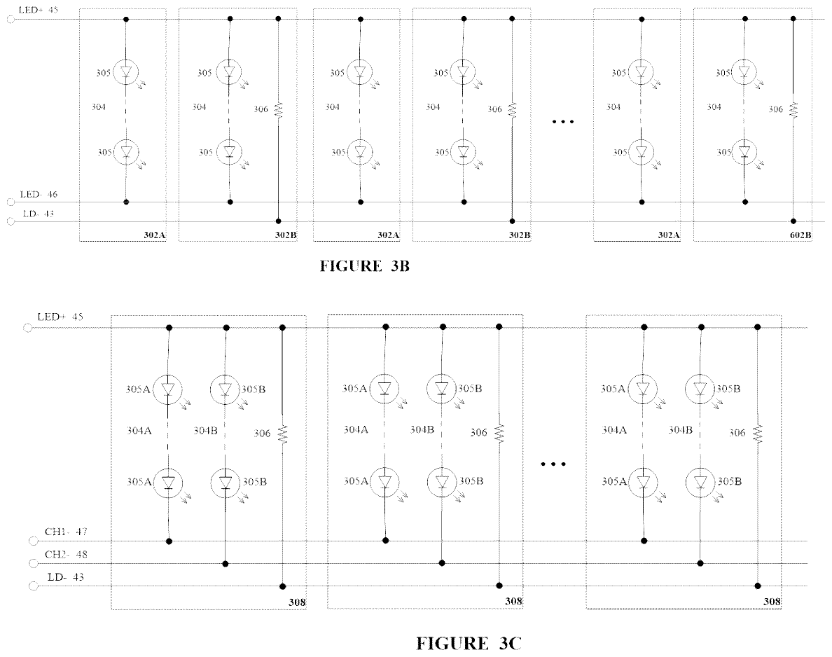

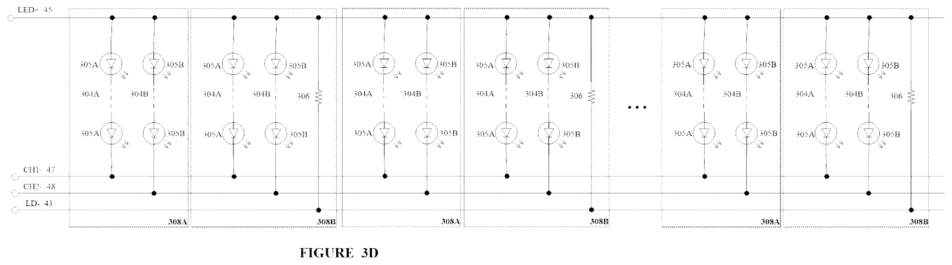

With reference to FIG. 1A and according to an embodiment of the present invention, a lighting apparatus 5A comprises a constant voltage driver 10A coupled via a control apparatus 20A to a lighting array with adjustable segments, and therefore adjustable electrical requirements, such as a cuttable light emitting diode (LED) tape 15. The control apparatus 20A, according to one embodiment, will be described further with reference to FIG. 2. Specific embodiments of the LED tape 15 will be described with reference to FIGS. 3A and 3B. Although shown as LED tape 15 in FIG. 1A, in other embodiments, the lighting array may be a LED module built on a discrete printed circuit board (PCB) that may be rigid or flexible and may be cuttable or breakable or may be otherwise adjustable such that the electrical requirements of the lighting array may change and/or may need to be programmed by a driver after the adjustment.

In the embodiment of FIG. 1A, the constant voltage driver 10A is coupled to the control apparatus 20A via positive voltage rail 40 and return voltage rail 42 and converts an AC input to a specific DC output voltage onto the rails 40,42. The control apparatus 20A is powered by the voltage rails 40,42 and is operable to control a specified current on the LED tape 15 through LED positive rail 45 and LED return rail 46. In some embodiments, the control apparatus 20A is operable to convert the constant voltage on rails 40,42 to a constant current to be applied to LEDs on the LED tape 15 using a voltage converter (not shown). For example, the control apparatus 20A may comprise a voltage converter as disclosed in U.S. Pat. No. 10,757,784 filed Feb. 20, 2017 by Briggs, herein incorporated by reference. In some embodiments, other architectures for outputting a constant current can be employed as one skilled in the art would understand. Further, the control apparatus 20A comprises a controller 22 and an interface 24. The controller 22 may comprise a microcontroller or other computing element that can control one or more operations within the control apparatus 20A. The interface 24 may comprise a connector or other interface element to support the coupling of the control apparatus 20A to the LED tape 15.

As shown in FIG. 1A, the control apparatus 20A is coupled to the LED tape 15 via a positive voltage rail 45 denoted LED+, a return voltage rail 46 denoted LED− and a length detection (LD) rail 43 denoted LD−. In this embodiment, the control apparatus 20A powers LED paths within the LED tape 15 by applying a controlled current through positive and return voltage rails 45,46. Further, in some embodiments of the present invention, the control apparatus 20A is operable to determine an indication of the length of the LED tape 15 by applying a reference voltage across positive voltage rail 45 and LD rail 43 and sensing a current flowing. In other embodiments, the control apparatus 20A is operable to determine an indication of the length of the LED tape 15 by applying a reference current through positive voltage rail 45 and LD rail 43 and sensing a voltage across the positive voltage rail 45 and LD rail 43.

FIG. 2 depicts a block diagram of the control apparatus 20A according to one specific embodiment of the present invention. As shown, the controller 22 comprises an analog-to-digital converter (ADC) 25 and control apparatus 20A comprises a voltage converter 35 coupled to the positive voltage rail 45 and the LD rail 43 and a current sense module 30 coupled to the voltage converter 35. The voltage converter 35 is operable to receive a signal 50 from the controller 22 which can be used to maintain a specified voltage on the output of the voltage converter 35. In other embodiments, the signal 50 may be used to maintain a specific current on the output of the voltage converter 35. In one embodiment, the voltage converter 35 may be a voltage step down controller such as a reverse buck converter and, in other embodiments, the voltage converter 35 may be implemented in other manners including a boost converter, buck/boost converter or other voltage control apparatus. The current sense module 30 is operable to generate an indication 52 of a current flowing through the positive voltage rail 45 to the LD rail 43 or a current flowing in the voltage converter 35 that represents the current flowing through rails 45, 43. The indication 52 of the current may be a voltage across a resistor of known resistance within the current sense module 30 or may be an output from an integrated circuit (IC) current sense element. The indication 52 of the current is input to the ADC 25 and enables the controller 22 to determine a level of current flowing through the current sense module 30. In the case that the controller 22 is maintaining a reference voltage on the output of the voltage converter 35, the controller 22 can use the level of current flowing through the current sense module 30 as an indication of the length of the LED tape 15 as the current measured by the current sense module 30 can be an indication of a number of reference elements, such as resistors, that are in parallel with each other between the positive voltage rail 45 and the LD rail 43. In the case that the controller 22 is maintaining a reference current on the output of the voltage converter 35, the controller 22 can use the level of current flowing through the current sense module 30 to determine the signal 50 to apply to the voltage converter 35 in a current feedback system. The controller 22 can then further detect the voltage output from the voltage converter 35 and use this measurement as an indication of the length of the LED tape 15 as the voltage measured on the output of the voltage converter 35 can be an indication of a number of reference elements, such as resistors, that are in parallel with each other between the positive voltage rail 45 and the LD rail 43.

In the embodiment of FIGS. 1A and 2, the control apparatus 20A may control intensity of light (ie dimming) of the LEDs in the LED tape 15 by controlling the current output through positive and return voltage rails 45,46, which is called constant current reduction (CCR) dimming. In other embodiments, the control apparatus 20A may control the intensity of light of the LEDs in the LED tape 15 using PWM or a hybrid architecture which includes both CCR and PWM. Further, although the controller 22 is determining an indication of the length of the LED tape 15 by controlling a reference voltage or reference current between the positive voltage rail 45 and the LD rail 43, in other embodiments, the LD rail may be a positive rail and the controller 22 may determine an indication of the length of the LED tape 15 by controlling a reference voltage or reference current between the LD rail and the return voltage rail 46.

In the lighting apparatus 5A of FIG. 1A, the driver 10A and the control apparatus 20A are distinct components that operate together to convert the AC to DC and control the current flowing through the LEDs of the LED tape 15. In some embodiments, functionality of the driver 10A and the control apparatus 20A are integrated together in a driver 10B as depicted in FIG. 1B. In this embodiment, a lighting apparatus 5B comprises a driver 10B which further comprises a control apparatus 20B. In this embodiment, various different components and functionality could be integrated together for a variety of reasons one skilled in the art would understand including to reduce costs, to minimize the form factor size or shape, and/or make the overall apparatus more efficient. In other embodiments, the integrated driver 10B may simply comprise the driver 10A and the control apparatus 20A in the same encasement.

In the lighting apparatus 5A of FIG. 1A, the control apparatus 20A is operable to determine an indication of the length of the LED tape 15 and also to control the current to the LEDs in the LED tape 15. In some embodiments, the control apparatus may not control the current to the LEDs in the LED tape 15 as depicted in FIG. 1C. In this embodiment, a lighting apparatus 5C comprises a constant current driver 10C and a control apparatus 20C along with the LED tape 15. In this case, the control apparatus 20C can operate as described with reference to FIG. 2 in order to determine an indication of a length of the LED tape 15 and then utilize this information to control the constant current driver 10C. The control over the constant current driver 10C could be implemented in a variety of manners including controlling a control protocol input to the constant current driver (ex. 0-10V, DMX, DALI, wireless, Triac, etc.), adjusting a programming of the constant current driver, or through a more integrated solution (ex. UART, API, etc). In some embodiments, the control apparatus 20C may not control the constant current driver 10C but instead may provide a user output indication by visual display, audio or otherwise to a user or another computing element that can control the constant current driver 10C either directly or indirectly.

In the lighting apparatus 5A of FIG. 1A, the control apparatus 20A outputs a single output channel to the LED tape 15 through positive and return voltage rails 45,46 which can control a single channel of LEDs in the LED tape 15. In some embodiments of the present invention, the LED tape may comprise two or more LED channels of LEDs which are operable to be controlled separately. For example, some LED tape may comprise 2 or 3 LED channels of white LEDs with different color temperatures (CCTs) so that, when controlled properly, a desired mix of the LED channels can be used to generate light output from the lighting apparatus at a desired CCT. Further, for example, some LED tape may comprise one or more LED channels of color LEDs (ex. red, green, blue, amber, etc) and further may comprise one or more LED channels of white LEDs (ex. warm CCT LEDs, cool CCT LEDs). In these examples, the controller can control a desired mix of the LED channels in order to generate light output from the lighting apparatus at a desired color spectra or desired CCT with specific quality specifics (ex. high CRI, low DUV). FIG. 1D illustrates a lighting apparatus 5D that comprises a LED tape 15A that comprises a plurality of LED channels, each channel comprising LEDs of a different specification (ex. different CCT, color, etc). As shown, the control apparatus 20A is replaced with a control apparatus 20D that outputs a plurality of controlled outputs to the LED tape 15A. In this case, control apparatus 20D and LED tape 15A are coupled together by positive voltage rail 45 denoted by LED+, channel 1 return rail 47 denoted CH1−, channel 2 return rail 48 denoted CH2− and channel n return rail denoted CHn− 49. In this implementation, the control apparatus 20D controls n LED channels in the LED tape 15A. This could be done with a separate current feedback controlled voltage converter (ex. buck converter, boost converter, buck-boost converter etc) or by other current control architectures. Further, the control apparatus 20D may control the n LED channels in the LED tape 15A using current steering in which a single current source is time multiplexed between LED channels using separate PWM controls on each LED channel. Specific embodiments of the LED tape 15A is described with reference to FIGS. 3C and 3D.

In the embodiment of FIG. 1D, a common positive (positive voltage rail 45) is used to power the plurality of LED channels in the LED tape 15A. In other embodiments, it should be understood that a common return rail could be used. In this embodiment, the control apparatus would control a separate positive voltage rail for each LED channel in the LED tape 15A and the current would flow for each LED channel from their respective positive channel rail and a common return rail. In other embodiments, the control apparatus 20D and the LED tape 15A could have a separate positive voltage rail and a separate return voltage rail per LED channel in the LED tape 15A. The particular number of LED channels within the LED tape and the wiring configuration or dimming architecture for the LED channels should not limit the scope of the present invention.

FIGS. 3A and 3B are circuit diagrams of the LED tape 15 according to various embodiments of the present invention. With reference to FIG. 3A and according to an embodiment of the present disclosure, the LED tape 15 comprises a plurality of connected segments 302. In this embodiment, each one of the connected segments 302 is comprised of a LED path 304 connected between the positive voltage rail 45 and the return voltage rail 46 and a reference path 306 connected between the positive voltage rail 45 and the LD rail 43. As shown, the positive voltage rail 45 is denoted as LED+, the return voltage rail 46 is denoted as LED− and the LD rail 43 is denoted as LD−. In embodiments of the present invention, the LED tape 15 of FIG. 3A is cuttable between any one of the plurality of segments 302. The specific cutting of the LED tape 15 between any of the segments 302 may be dependent upon a desired physical length of the LED tape 15, potentially to allow the LED tape to fit within a particular encasement or within a specific location within an installation.

The LED path 304 is comprised of one or more LEDs 305 in series electrical connection with one another. In FIG. 3A, two LEDs 305 are depicted for each of the LED paths 304 but one skilled in the art would understand that other numbers of LEDs may comprise each of the LED paths 304. In some embodiments, the LED paths 304 may comprise a plurality of sets of LEDs in parallel with each other, each set of LEDs comprising one or more LEDs in series. In some embodiments, the LED paths 304 may further comprise a resistor coupled electrically in series with the LEDs 305 to mitigate current imbalance across the LED paths in the LED tape 15. The LED paths 304 in each segment 302 are each in parallel with the other LED paths 304 in the other segments 302 between the positive voltage rail 45 and the return voltage rail 46. The forward voltage required to turn on the LEDs 305 should be substantially similar in each of the LED paths 304 across the segments 302 to mitigate potential of imbalances of current flowing through the LED paths 304 in operation, also known as current hogging.

The reference path 306 comprises a reference element which is a passive electrical component, depicted in FIG. 3A as a single resistor. It should be understood that in other embodiments the reference element may comprise a plurality of resistors or may comprise another passive electrical component that can be used as a reference element as will be described to determine a length of the LED tape 15. The reference paths 306 in each segment 302 are each in parallel with the other reference paths 306 in the other segments 302 between the positive voltage rail 45 and the LD rail 43. In the case that the reference paths 306 comprise a resistor as depicted in FIG. 3A, the resistance of the reference paths 306 should be substantially similar in each of the reference paths 306 across the segments 302. Specifying resistors for the reference paths 306 with low tolerances can improve accuracy of the operation of determining the length of the LED tape 15.

With reference to FIG. 3B and according to an embodiment of the present disclosure, the LED tape 15 may comprise a plurality of connected segments 302A, 302B. In this embodiment, each one of the connected segments 302A, 302B comprises a LED path 304 connected between the positive voltage rail 45 and the return voltage rail 46 and a limited set of the connected segments 302B further comprises a reference path 306 connected between the positive voltage rail 45 and the LD rail 43. In this embodiment, a set of the connected segments 302A does not comprise a reference path 306. As shown, the positive voltage rail 45 is denoted as LED+, the return voltage rail 46 is denoted as LED− and the LD rail 43 is denoted as LD−. In embodiments of the present invention, the LED tape 15 of FIG. 3B is cuttable between any one of the plurality of segments 302A,302B. The specific cutting of the LED tape 15 between any of the segments 302A,302B may be dependent upon a desired physical length of the LED tape 15, potentially to allow the LED tape to fit within a particular encasement or within a specific location within an installation.

Similar to FIG. 3A, the LED path 304 is comprised of one or more LEDs 305 in series electrical connection with one another. In FIG. 3B, two LEDs 305 are depicted for each of the LED paths 304 but one skilled in the art would understand that other numbers of LEDs may comprise each of the LED paths 304. In some embodiments, the LED paths 304 may comprise a plurality of sets of LEDs in parallel with each other, each set of LEDs comprising one or more LEDs in series. In some embodiments, the LED paths 304 may further comprise a resistor coupled electrically in series with the LEDs 305 to mitigate current imbalance across the LED paths 304 in the LED tape 15. The LED paths 304 in each segment 302A,302B are each in parallel with the other LED paths 304 in the other segments 302A,302B between the positive voltage rail 45 and the return voltage rail 46. The forward voltage required to turn on the LEDs 305 should be substantially similar in each of the LED paths 304 across the segments 302A,302B to mitigate potential of imbalances of current flowing through the LED paths 304 in operation, also known as current hogging.

Similar to FIG. 3A, the reference path 306 comprises a reference element which is a passive electrical component, depicted in FIG. 3B as a single resistor. It should be understood that in other embodiments the reference element may comprise a plurality of resistors or may comprise another passive electrical component that can be used as a reference element as will be described to determine a length of the LED tape 15. The reference paths 306 in each segment 302B are each in parallel with the other reference paths 306 in the other segments 302B between the positive voltage rail 45 and the LD rail 43. In the case that the reference paths 306 comprise a resistor as depicted in FIG. 3B, the resistance of the reference paths 306 should be substantially similar in each of the reference paths 306 across the segments 302B. Specifying resistors for the reference paths 306 with low tolerances can improve accuracy of the operation of determining the length of the LED tape 15.

In the LED tape 15 of FIG. 3B, the set of connected segments 302B that comprise the reference path 306 may be spread out at predetermined intervals along the length of the LED tape 15. For example, the set of connected segments 302B that comprise the reference path 306 may be spaced every five segments. In this case, when determining a length of the LED tape 15, the control apparatus may extrapolate that for every reference path 306 detected, five segments 302A,302B that each comprise one of the LED paths 304 are present in the LED tape 15. In some embodiments, a look-up table used by the control apparatus may have electrical settings for the LEDs 305 in the LED tape 15 that are based on the known number of segments 302A,302B (and therefore LED paths 304) represented by each of the reference paths 306. In the embodiment of FIG. 3A, one LED path 304 is represented by each of the reference paths 306 as every segment 302 comprises both the LED path 304 and the reference path 306. In the embodiment of FIG. 3B, a plurality of LED paths 304 is represented by each of the reference paths 306 as only segments 302B comprise both the LED path 304 and the reference path 306.

FIGS. 3C and 3D are circuit diagrams of the LED tape 15A according to various embodiments of the present invention. With reference to FIG. 3C and according to an embodiment of the present disclosure, the LED tape 15A comprises a plurality of connected segments 308. In this embodiment, each one of the connected segments 308 is comprised of a first LED path 304A connected between the positive voltage rail 45 and the channel 1 return rail 47, a second LED path 304B connected between the positive voltage rail 45 and the channel 2 return rail 48 and a reference path 306 connected between the positive voltage rail 45 and the LD rail 43. With reference to FIG. 3D and according to an embodiment of the present disclosure, the LED tape 15A may comprise a plurality of connected segments 308A, 308B. In this embodiment, each one of the connected segments 308A, 308B comprises a first LED path 304A connected between the positive voltage rail 45 and the channel 1 return rail 47 and a second LED path 304B connected between the positive voltage rail 45 and the channel 2 return rail 48, and a limited set of the connected segments 308B further comprises a reference path 306 connected between the positive voltage rail 45 and the LD rail 43. In this embodiment, a set of the connected segments 308A does not comprise a reference path 306. As shown, the positive voltage rail 45 is denoted as LED+, the channel 1 return rail 47 is denoted as CH1−, the channel 2 return rail 48 is denoted as CH2− and the LD rail 43 is denoted as LD−. The reference paths 306 in FIGS. 3C and 3D are similar to that described with reference to FIGS. 3A and 3B. In embodiments of the present invention, the LED tape 15A of FIGS. 3C,3D are cuttable between any one of the plurality of segments 308,308A,308B. The specific cutting of the LED tape 15A between any of the segments 308,308A,308B may be dependent upon a desired physical length of the LED tape 15A, potentially to allow the LED tape 15A to fit within a particular encasement or within a specific location within an installation.

As shown in FIGS. 3C and 3D, the first LED path 304A is comprised of one or more LEDs 305A in series electrical connection with one another. As depicted, two LEDs 305A are depicted for each of the first LED paths 304A but one skilled in the art would understand that other numbers of LEDs may comprise each of the first LED paths 304A. In some embodiments, the first LED paths 304A may comprise a plurality of sets of LEDs in parallel with each other, each set of LEDs comprising one or more LEDs in series. In some embodiments, the LED paths 304A,304B may further comprise a resistor coupled electrically in series with the LEDs 305A and a resistor coupled electrically in series with the LEDs 305B to mitigate current imbalance across the LED paths 304A,304B in the LED tape 15. The first LED paths 304A in each segment 308 are each in parallel with the other first LED paths 304A in the other segments 308 between the positive voltage rail 45 and the channel 1 return rail 47. The forward voltage required to turn on the LEDs 305A should be substantially similar in each of the first LED paths 304A across the segments 308 to mitigate potential of imbalances of current flowing through the first LED paths 304A in operation, also known as current hogging.

As shown in FIGS. 3C and 3D, the second LED path 304B is comprised of one or more LEDs 305B in series electrical connection with one another. As depicted, two LEDs 305B are depicted for each of the second LED paths 304B but one skilled in the art would understand that other numbers of LEDs may comprise each of the second LED paths 304B. In some embodiments, the second LED paths 304B may comprise a plurality of sets of LEDs in parallel with each other, each set of LEDs comprising one or more LEDs in series. The second LED paths 304B in each segment 308 are each in parallel with the other second LED paths 304B in the other segments 308 between the positive voltage rail 45 and the channel 2 return rail 48. The forward voltage required to turn on the LEDs 305B should be substantially similar in each of the second LED paths 304B across the segments 308 to mitigate potential of imbalances of current flowing through the second LED paths 304B in operation, also known as current hogging.

The LEDs 305A of the first LED paths 304A and the LEDs 305B of the second LED paths 304B may be different in a number of ways depending upon a desired light output for the LED tape 15A. In some embodiments, the LEDs 305A and the LEDs 305B may both be white LEDs with different color temperatures (CCT). In other embodiments, the LEDs 305A and the LEDs 305B may be different color LEDs. In yet other embodiments, the LEDs 305A and the LEDs 305B may have other differences such as different lumen outputs, different forward voltages or different mix of spectra (ex. similar CCT but with different spectra such as a higher or lower level of cyan content). In yet other embodiments, the LEDs 305A and the LEDs 305B may be similar LEDs and may simply be controlled separately or together.

Although the segments 308 depicted of FIG. 3C and the segments 308A,308B of FIG. 3D, comprise two LED paths 304A,304B, one skilled in the art would understand that more than two LED paths may be included in each segment 308,308A,308B in some embodiments. In some cases, each segment 308,308A,308B may comprise third LED paths, fourth LED paths or more LED paths each with one or more LEDs. The LEDs across these plurality of LED paths in the segments may comprise different color LEDs or may comprise LEDs with other differences. For example, each segment 308,308A,308B may comprise three LED paths, each of the three LED paths comprising white LEDs with a different color temperature (CCT). In another example, each segment 308,308A,308B may comprise four LED paths, each of the four LED paths comprising LEDs with a different color (ex, red, green, blue, white). In another example, each segment 308,308A,308B may comprise five LED paths, each of the five LED paths comprising LEDs with a different color (ex, red, green, blue, warm white, cool white).

In FIGS. 3C and 3D, the first LED paths 304A and the second LED paths 304B within the segments 308,308A,308B are connected between a common positive rail (specifically, the positive voltage rail 45), and a respective channel specific return rail (specifically, the channel 1 return rail 47 and the channel 2 return rail 48 respectively). In other embodiments, the first and second LED paths 304A, 304B may be connected to a common return rail and to separate channel specific positive rails. In this case, the control apparatus could control the first LED paths 304A by controlling a voltage between a channel 1 specific positive rail and the common return rail and control the second LED paths 304B by controlling a voltage between a channel 2 specific positive rail and the common return rail. In yet other embodiments, the first LED paths 304A in the segments 308,308A,308B may be connected between a channel 1 specific positive rail and a channel 1 specific return rail and the second LED paths 304A in the segments 308,308A,308B may be connected between a channel 2 specific positive rail and a channel 2 specific return rail. In this case, the control apparatus could control the first LED paths 304A by controlling a voltage between the channel 1 specific positive rail and the channel 1 specific return rail and control the second LED paths 304B by controlling a voltage between the channel 2 specific positive rail and the channel 2 specific return rail.

The reference paths 306 comprise a reference element which is a passive electrical component, depicted in FIGS. 3A,3B,3C,3D as a single resistor. It should be understood that in other embodiments the reference element may comprise a plurality of resistors or may comprise another passive electrical component that can be used as a reference element. For example, in other embodiments, the reference element may comprise a capacitor of a known capacitance, an inductor of a known inductance, an LED with a known forward voltage at a particular current, a resistor of a known resistance, or a combination of two of more passive electrical components that may form a passive circuit. Depending on the composition of the reference element, the control apparatus is operable to determine the number of reference elements that are in parallel. This may be done in different manners, depending on the passive electrical component or combination of components that are in parallel.

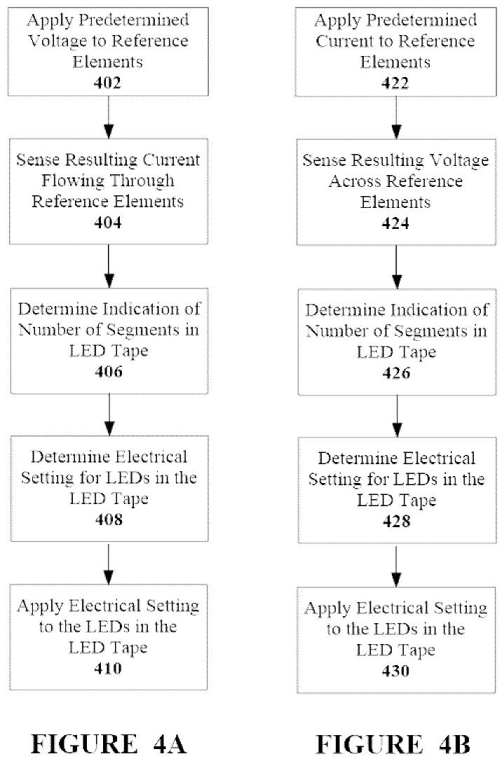

With reference to FIG. 4A and according to an embodiment of the present disclosure, an embodiment of the lighting apparatus 5A is described, along with a method of determining an indication of a number of the connected segments 302 in the LED tape 15 as performed by the control apparatus 20A or the controller 22. The method of FIG. 4A may be initiated when the lighting apparatus 5A is activated, during an initial provisioning cycle, regularly during operation, or another time as may be triggered or scheduled within the control apparatus 20A. At step 402, the control apparatus 20A applies a predetermined voltage across the positive voltage rail 45 and the LD rail 43. This predetermined voltage is applied across the reference paths 306 within each of the segments 302 of the LED tape 15. Once the predetermined voltage has been applied at step 402, the control apparatus 20A senses the resulting current value I flowing from the positive voltage rail 45 to the LD rail 43 at step 404. The sensing of the resulting current value may be implemented in a variety of manners as one skilled in the art would understand. For example, the current sense module 30 of FIG. 2 may comprise a resistor of known resistance in series with the plurality of parallel connected reference paths 306 of the LED tape 15 and the current sense module 30 may output an indication of the current flowing through the reference elements by applying a sensed voltage (depicted as indication 52) to the ADC 25. Alternatively, the current sense module 30 may comprise an integrated circuit (IC) current sense element which will output an indication of the current value I to the ADC 25. The output from the ADC 25 may be a digital representation of the indication 52, which will depend partially on the resolution of the ADC 25. The control apparatus 20A may sense the current value I flowing from the positive voltage rail 45 to the LD rail 43 or may determine an indication of the current flowing from the positive voltage rail 45 to the LED rail 43, the indication being the indication 52 of the current sense module 30, the digital representation of the indication 52 output from the ADC 25 or another indication of the current as one skilled in the art would understand.

The control apparatus 20A determines an indication of the number N of connected segments 302 of the LED tape 15 at step 406 based at least on the indication of the current value I sensed, the indication of the number N being a value related to the number of connected segments 302. The number N can be determined by using Ohm's Law: R/N=V/I, whereby the resistance value of the reference elements in each of the reference paths 306 is R, the voltage applied to the reference elements in the reference paths 306 is V and the resulting current value sensed is I. In this case, N=(R/V)*I and since the resistor value R and the voltage value V are known, the current I itself is effectively an indication of the number of connected segments 302 in the LED tape 15. In some embodiments, the control apparatus 20A may compute the actual number of connected segments 302 of the LED tape 15 by using the known V and R values and the sensed I value. In other embodiments, the control apparatus 20A does not actually compute the value N and instead determines an indication of the number N of connected segments 302 of the LED tape 15. The indication of the number N of connected segments 302 may, for example, comprise: a computed value of the current I flowing through the reference elements in the LED tape 15, a sensed voltage output from the current sense module 30, a digital representation of the sensed voltage output from the ADC 25, or another value that can be used to associate with the number of reference paths 306 that are in parallel within the LED tape 15.

In embodiments in which the LED tape 15 of FIG. 3B or the LED tape 15A of FIG. 3D is utilized in which reference paths 306 are in a limited set of segments 302B,308B of the overall segments, the control apparatus 20A may apply a multiple to the number of segments of the LED tape based on a proportion of the overall segments that are segments 302B,308B with reference paths 306. In some embodiments, the indication of the number of segments of the LED tape 15 does not change and may, for example, comprise: a computed value of the current I flowing through the reference elements in the LED tape 15, a sensed voltage output from the current sense module 30, a digital representation of the sensed voltage output from the ADC 25, or another value that can be used to associate with the number of reference paths 306 that are in parallel within the LED tape 15. In this case, the control apparatus 20A may use information on the proportion of the overall segments that are segments 302B,308B with reference paths 306 when using the indication of number of segments of the LED tape 15.

In some embodiments, at step 408, the control apparatus 20A is further configured to determine an electrical setting of the LEDs 305 in the LED tape 15 based on the indication of the number N of connected segments 302. By way of example, not intended to be limiting, an electrical setting may include a maximum operating current of the LEDs 305 or a programmed operating current of the LEDs 305. To determine the electrical setting, the control apparatus 20A may access a database comprising a plurality of records, each record indicating an electrical setting to be applied. The database may comprise a look-up table or a set of formulas to determine the appropriate electrical setting. By way of example, a look-up table may associate a list of potential indications of the number of segments 302 of the LED tape 15 to a list of corresponding electrical settings for the LEDs 305. In one particular example, a number of bits output from the ADC 25 may be an indication of the current flowing through the reference elements within the LED tape 15 and therefore may be an indication of the number of segments 302 of the LED tape 15. In this case, the look-up table may comprise a list of number of bits output from the ADC 25 and a list of electrical settings for the LEDs 305 that are linked to a particular number of bits output from the ADC 25 for the predetermined voltage being applied across the positive voltage rail 45 and the LD rail 43.

In other embodiments, the control apparatus 20A may access a database that includes a look-up table that associates a list of potential indications of the number of segments 302 of the LED tape 15 to a number of segments 302 of the LED tape 15. In this case, the computing apparatus 20A can use the look-up table to determine a number of segments 302 of the LED tape 15 based on the indications, and calculate an electrical setting for the LEDs 305 using the determined number of segments 302. For example, the computing apparatus 20A may multiply the number of segments 302 by a maximum current per segment or a desired current per segment in order to determine a maximum current to apply to the LEDs 305 in the LED tape 15 or to determine a desired programmed current to apply to the LEDs 305 in the LED tape 15. The determining of an electrical setting for the LEDs 305 using the indication of the number of segments 302 of the LED tape 15 can further be implemented in other manners using look-up tables of various implementation and/or computing an electrical setting from the indication of the number of segments 302 or from the output of a look-up table using the indication of the number of segments. The actual implementation of the control apparatus 20A determining the electrical setting for the LEDs 305 should not limit the scope of the present invention.

In other embodiments as described with reference to the lighting apparatus 5D of FIG. 1D and the LED tape 15A of FIGS. 3C and 3D, in the case that the segments 308,308A,308B comprise a plurality of LED paths 304A,304B, the electrical setting may include a maximum operating current corresponding to each of the sets of LEDs 305A,305B, a programmed current for each of the sets of LEDs 305A,305B, or a calibrated mix of the different sets of LEDs 305A,305B. Similar to described above, the control apparatus 20A may use a look-up table to determine the electrical settings for the LEDs 305A,305B using the indication of the number of segments 308,308A,308B of the LED tape 15A; compute the electrical settings for the LEDs 305A,305B using the indication of the number of segments 308,308A,308B of the LED tape 15A; and/or a combination of look-up tables and computations to determine the electrical settings for the LEDs 305A,305B.

In embodiments in which the LED tape 15 of FIG. 3B or the LED tape 15A of FIG. 3D is utilized in which reference paths 306 are in a limited set of segments 302B,308B of the overall segments, the database accessed by the control apparatus 20A to determine the electrical settings for the LEDs may have records that are adjusted to compensate for the proportion of the overall segments that are segments 302B,308B with reference paths 306. In other embodiments, the control apparatus 20A may make adjustments to the determined number of segments of the LED tape 15 or the indication of the number of segments based on the proportion of the overall segments that are segments 302B,308B with reference paths 306.

In some embodiments, at step 410, the control apparatus 20A is further configured to apply the electrical setting to the LEDs 305 in the LED tape 15. In some cases, to apply the electrical setting to the LEDs 305, the control apparatus 20A controls the current applied to the LEDs 305 by controlling the current flowing from the positive voltage rail 45 to the return voltage rail 46. In some embodiments, the control apparatus 20A may apply a maximum current to apply across the LEDs 305 based on the electrical setting of the LEDs 305 and the control apparatus 20A may reduce the current across the LEDs 305 (and therefore dim the intensity of the LEDs 305) from the maximum current, in response to a user input. In other embodiments, the control apparatus 20A may apply a programmed current to apply across the LEDs 305 based on the electrical setting of the LEDs 305 and the control apparatus 20A may either not dim the intensity of the LEDs 305 or may reduce the intensity of the LEDs 305 using other dimming techniques as one skilled in the art would understand, such as, but not limited to, PWM dimming or a hybrid of CCR and PWM dimming.

In the case of the lighting apparatus 5A, 5B of FIGS. 1A and 1B, the control apparatus 20A,20B may be operable to directly apply the electrical setting of the LEDs 305 to the LEDs 305, though the control apparatus 20B of FIG. 1B may utilize other elements of the driver 10B. In the case of the lighting apparatus 5C of FIG. 1C, the control apparatus 20C may control the constant current driver 10C to control the electrical setting of the LEDs 305 on the LEDs 305. The control over the constant current driver 10C could be implemented in a variety of manners including controlling a control protocol input to the constant current driver (ex. 0-10V, DMX, DALI, wireless, Triac, etc.), adjusting a programming of the constant current driver, or through a more integrated solution (ex. UART, API, etc). In the case of the lighting apparatus 5D of FIG. 1D, the control apparatus 20D may be operable to directly apply the electrical settings of the LEDs 305A,305B to the LEDs 305A,305B. In this case, to apply the electrical setting to the LEDs 305A,305B, the control apparatus 20D may control the current applied to the LEDs 305A by controlling the current flowing from the positive voltage rail 45 to the channel 1 return rail 47; may control the current applied to the LEDs 305B by controlling the current flowing from the positive voltage rail 45 to the channel 2 return rail 48; and may control the current applied to other sets of LEDs that may be implemented in the LED tape 15A by controlling the current flowing from the positive voltage rail 45 to the channel n return rail 49.

With reference to FIG. 4B and according to an embodiment of the present disclosure, an embodiment of the lighting apparatus 5A is described, along with a method of determining an indication of a number of the connected segments 302 in the LED tape 15 as performed by the control apparatus 20A or the controller 22. The method of FIG. 4B may be initiated when the lighting apparatus 5A is activated, during an initial provisioning cycle, regularly during operation, or another time as may be triggered or scheduled within the control apparatus 20A. At step 422, the control apparatus 20A applies a predetermined current flowing from the positive voltage rail 45 to the LD rail 43. The control apparatus 20A may apply the predetermined current by measuring the current flowing between the positive voltage rail 45 and the LD rail 43 using the current sense module 30 and ADC 25 and then controlling the voltage converter 35 to achieve the desired predetermined current. The predetermined current will be divided among the reference paths 306 within the segments 302 of the LED tape 15 which are electrically in parallel. Once the predetermined current has been applied at step 422, the control apparatus 20A senses the resulting voltage V between the positive voltage rail 45 and the LD rail 43 at step 424. The sensing of the resulting voltage V may be done in a variety of manners as one skilled in the art would understand. For example, the controller 22 may directly measure a voltage level on the positive voltage rail 45 and a voltage level on the LD rail 43 required to maintain the predetermined current flowing from the positive voltage rail 45 to the LD rail 43, may have another ADC that generates a digital representation of these voltage levels, and may subtract the two voltages to determine the voltage between the positive voltage rail 45 and the LD rail 43. In other cases, the controller 22 may interpolate an indication of the voltage between the positive voltage rail 45 and the LD rail 43 using the level of the signal 50 used to control the voltage converter 35 to maintain the predetermined current.

The control apparatus 20A determines an indication of the number N of connected segments 302 of the LED tape 15 at step 426 based at least on the indication of the voltage value V sensed, the indication of the number N being a value related to the number of connected segments 302. The number N can be determined by using Ohm's Law: R/N=V/I, whereby the resistance value of the reference elements in each of the reference paths 306 is R, the current applied to the combined reference elements in the reference paths 306 which are in parallel with each other is I and the resulting voltage sensed between the positive voltage rail 45 and the LD rail 43 is V. In this case, N=(R/V)*I and since the resistor value R and the current value I are known, the voltage V itself is effectively an indication of the number of connected segments 302 in the LED tape 15. In some embodiments, the control apparatus 20A may compute the actual number of connected segments 302 of the LED tape 15 by using the known I and R values and the sensed V value. In other embodiments, the control apparatus 20A does not actually compute the value N and instead determines an indication of the number N of connected segments 302 of the LED tape 15. The indication of the number N of connected segments 302 may, for example, comprise: a computed value of the voltage V between the positive voltage rail 45 and the LD rail 43, a sensed voltage between the positive voltage rail 45 and the LD rail 43, a digital representation of the sensed voltage between the positive voltage rail 45 and the LD rail 43, or another value that can be used to associate with the number of reference paths 306 that are in parallel within the LED tape 15.

In embodiments in which the LED tape 15 of FIG. 3B or the LED tape 15A of FIG. 3D is utilized in which reference paths 306 are in a limited set of segments 302B,308B of the overall segments, the control apparatus 20A may apply a multiple to the number of segments of the LED tape based on a proportion of the overall segments that are segments 302B,308B with reference paths 306. In some embodiments, the indication of the number of segments of the LED tape 15 does not change and may, for example, comprise: a computed value of the current I flowing through the reference elements in the LED tape 15, a sensed voltage output from the current sense module 30, a digital representation of the sensed voltage output from the ADC 25, or another value that can be used to associate with the number of reference paths 306 that are in parallel within the LED tape 15. In this case, the control apparatus 20A may use information on the proportion of the overall segments that are segments 302B,308B with reference paths 306 when using the indication of number of segments of the LED tape 15.

In some embodiments, at step 428, the control apparatus 20A is further configured to determine an electrical setting of the LEDs 305 in the LED tape 15 based on the indication of the number N of connected segments 302. By way of example, not intended to be limiting, an electrical setting may include a maximum operating current of the LEDs 305 or a programmed current of the LEDs 305. To determine the electrical setting, the control apparatus 20A may access a database comprising a plurality of records, each record indicating an electrical setting to be applied. The database may comprise a look-up table or a set of formulas to determine the appropriate electrical setting. By way of example, a look-up table may associate a list of potential indications of the number of segments 302 of the LED tape 15 to a list of corresponding electrical settings for the LEDs 305. In one particular example, a number of bits output from an ADC may be an indication of the voltage at the LD rail 43 and therefore may be an indication of the number of segments 302 of the LED tape 15. In this case, the look-up table may comprise a list of number of bits output from the ADC and a list of electrical settings for the LEDs 305 that are linked to a particular number of bits output from the ADC.

In other embodiments, the control apparatus 20A may access a database that includes a look-up table that associates a list of potential indications of the number of segments 302 of the LED tape 15 to a number of segments 302 of the LED tape 15. In this case, the computing apparatus 20A can use the look-up table to determine a number of segments 302 of the LED tape 15 based on the indications, and calculate an electrical setting for the LEDs 305 using the determined number of segments 302. For example, the computing apparatus 20A may multiply the number of segments 302 by a maximum current per segment or a desired current per segment in order to determine a maximum current to apply to the LEDs 305 in the LED tape 15 or to determine a desired programmed current to apply to the LEDs 305 in the LED tape 15. The determining of an electrical setting for the LEDs 305 using the indication of the number of segments 302 of the LED tape 15 can further be implemented in other manners using look-up tables of various implementation and/or computing an electrical setting from the indication of the number of segments 302 or from the output of a look-up table using the indication of the number of segments. The actual implementation of the control apparatus 20A determining the electrical setting for the LEDs 305 should not limit the scope of the present invention.

In other embodiments as described with reference to the lighting apparatus 5D of FIG. 1D and the LED tape 15A of FIGS. 3C and 3D, in the case that the segments 308,308A,308B comprise a plurality of LED paths 304A,304B, the electrical setting may include a maximum operating current corresponding to each of the sets of LEDs 305A,305B, a programmed current for each of the sets of LEDs 305A,305B, or a calibrated mix of the different sets of LEDs 305A,305B. Similar to described above, the control apparatus 20A may use a look-up table to determine the electrical settings for the LEDs 305A,305B using the indication of the number of segments 308,308A,308B of the LED tape 15A; compute the electrical settings for the LEDs 305A,305B using the indication of the number of segments 308,308A,308B of the LED tape 15A; and/or a combination of look-up tables and computations to determine the electrical settings for the LEDs 305A,305B.

In embodiments in which the LED tape 15 of FIG. 3B or the LED tape 15A of FIG. 3D is utilized in which reference paths 306 are in a limited set of segments 302B,308B of the overall segments, the database accessed by the control apparatus 20A to determine the electrical settings for the LEDs may have records that are adjusted to compensate for the proportion of the overall segments that are segments 302B,308B with reference paths 306. In other embodiments, the control apparatus 20A may make adjustments to the determined number of segments of the LED tape 15 or the indication of the number of segments based on the proportion of the overall segments that are segments 302B,308B with reference paths 306.

In some embodiments, at step 430, the control apparatus 20A is further configured to apply the electrical setting to the LEDs 305 in the LED tape 15. In some cases, to apply the electrical setting to the LEDs 305, the control apparatus 20A controls the current applied to the LEDs 305 by controlling the current flowing from the positive voltage rail 45 to the return voltage rail 46. In some embodiments, the control apparatus 20A may apply a maximum current to apply across the LEDs 305 based on the electrical setting of the LEDs 305 and the control apparatus 20A may reduce the current across the LEDs 305 (and therefore dim the intensity of the LEDs 305) from the maximum current, in response to a user input. In other embodiments, the control apparatus 20A may apply a programmed current to apply across the LEDs 305 based on the electrical setting of the LEDs 305 and the control apparatus 20A may either not dim the intensity of the LEDs 305 or may reduce the intensity of the LEDs 305 using other dimming techniques as one skilled in the art would understand, such as, but not limited to, PWM dimming or a hybrid of CCR and PWM dimming.

In the case of the lighting apparatus 5A, 5B of FIGS. 1A and 1B, the control apparatus 20A,20B may be operable to directly apply the electrical setting of the LEDs 305 to the LEDs 305, though the control apparatus 20B of FIG. 1B may utilize other elements of the driver 10B. In the case of the lighting apparatus 5C of FIG. 1C, the control apparatus 20C may control the constant current driver 10C to control the electrical setting of the LEDs 305 on the LEDs 305. The control over the constant current driver 10C could be implemented in a variety of manners including controlling a control protocol input to the constant current driver (ex. 0-10V, DMX, DALI, wireless, Triac, etc.), adjusting a programming of the constant current driver, or through a more integrated solution (ex. UART, API, etc). In the case of the lighting apparatus 5D of FIG. 1D, the control apparatus 20D may be operable to directly apply the electrical settings of the LEDs 305A,305B to the LEDs 305A,305B. In this case, to apply the electrical setting to the LEDs 305A,305B, the control apparatus 20D may control the current applied to the LEDs 305A by controlling the current flowing from the positive voltage rail 45 to the channel 1 return rail 47; may control the current applied to the LEDs 305B by controlling the current flowing from the positive voltage rail 45 to the channel 2 return rail 48; and may control the current applied to other sets of LEDs that may be implemented in the LED tape 15A by controlling the current flowing from the positive voltage rail 45 to the channel n return rail 49.

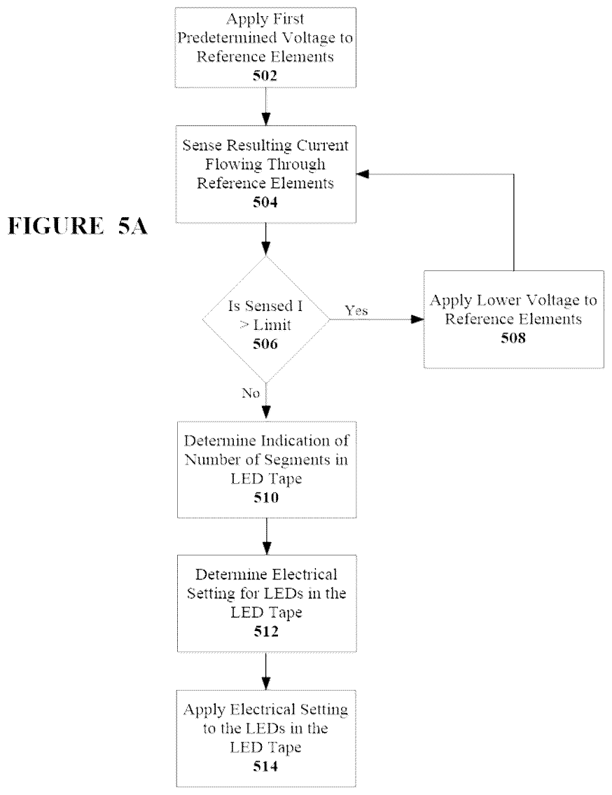

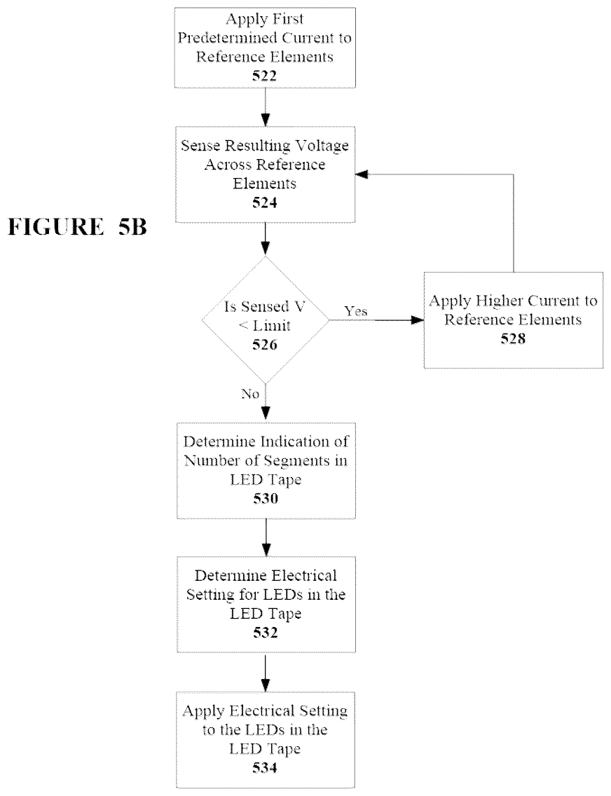

With reference to FIG. 5A and according to an embodiment of the present disclosure, an embodiment of the lighting apparatus 5A is described, along with a method of determining an indication of a number of the connected segments 302 in the LED tape 15 as performed by the control apparatus 20A or the controller 22. The method of FIG. 5A is an alternative implementation of the method of FIG. 4A in which more than one predetermined voltage may be applied between the positive voltage rail 45 and the LD rail 43. The application of different predetermined voltages between the positive voltage rail 45 and the LD rail 43 can enable the control apparatus 20A to distinguish between different numbers of segments 302 of the LED tape which might otherwise be outside a resolution limit. For example, the ADC 25 may have a limited resolution and be unable to distinguish between slight differences in sensed current at a first predetermined voltage across the positive voltage rail 45 and the LD rail 43 but may be able to distinguish these differences at a second predetermined voltage across the positive voltage rail 45 and the LD rail 43.

The method of FIG. 5A may be initiated when the lighting apparatus 5A is activated, during an initial provisioning cycle, regularly during operation, or another time as may be triggered or scheduled within the control apparatus 20A. At step 502, the control apparatus 20A applies a first predetermined voltage across the positive voltage rail 45 and the LD rail 43. This first predetermined voltage is applied across the reference paths 306 within each of the segments 302 of the LED tape 15. Once the first predetermined voltage has been applied at step 502, the control apparatus 20A senses the resulting current value I flowing through the plurality of reference elements in parallel within the LED tape 15 at step 504, similar to step 404 of FIG. 4A. In some embodiments, the control apparatus 20A determines the current value flowing from the positive voltage rail 45 to the LD rail 43 and, in other embodiments, the control apparatus 20A may determine an indication of the current value flowing which may be an output from the current sense module 30, a digital representation of the output from the current sense module 30 output from the ADC 25, or another indication of the current as one skilled in the art may understand.

As depicted at step 506 in FIG. 5A, the control apparatus 20A then compares the sensed current I or the indication of the sensed current I to a predetermined limit for assessing the number of segments 302 of the LED tape 15 using the first predetermined voltage. The limit for assessing the number of segments 302 of the LED tape 15 may be as a result of limitations in the control apparatus 20A being able to distinguish between different sensed currents based on different numbers of segments 302 of the LED tape 15, such as a resolution limitation of the ADC 25 or a tolerance limitation of the current sense module 30. In other embodiments, other limitations could apply to the ability of the control apparatus 20A being able to determine differences between the number of segments 302 of the LED tape 15. If the sensed current I or the indication of the sensed current I is greater than a predetermined limit for assessing the number of segments 302 of the LED tape 15 using the first predetermined voltage, the control apparatus 20A applies a second predetermined voltage, lower than the first predetermined voltage, across the positive voltage rail 45 and the LD rail 43 at step 508. This second predetermined voltage is applied across the reference paths 306 within each of the segments 302 of the LED tape 15. Once the second predetermined voltage has been applied at step 508, the control apparatus 20A repeats step 504 and senses the resulting current value I flowing through the plurality of reference elements in parallel within the LED tape 15. The control apparatus 20A may then repeat step 506 and compare the sensed current I or the indication of the sensed current I to a predetermined limit for assessing the number of segments 302 of the LED tape 15 using the second predetermined voltage. The process of steps 506, 508 and 504 may be repeated with a plurality of different predetermined voltages and a plurality of limits for assessing the number of segments 302 of the LED tape 15 using the respective predetermined voltages.

If the sensed current I or the indication of the sensed current I is equal or lower than the predetermined limit for assessing the number of segments 302 of the LED tape 15 using the predetermined voltage at step 506, in some embodiments, the control apparatus 20A determines an indication of the number N of connected segments 302 of the LED tape 15 at step 510 based at least on the indication of the current value I sensed, the indication of the number N being a value related to the number of connected segments 302. Step 510 is similar to step 406 described with reference to FIG. 4A. Similar to step 406, the indication of the number N of connected segments 302 may, for example, comprise: a computed value of the current I flowing through the reference elements in the LED tape 15, a sensed voltage output from the current sense module 30, a digital representation of the sensed voltage output from the ADC 25, or another value that can be used to associate with the number of reference paths 306 that are in parallel within the LED tape 15.

In embodiments in which the LED tape 15 of FIG. 3B or the LED tape 15A of FIG. 3D is utilized in which reference paths 306 are in a limited set of segments 302B,308B of the overall segments, the control apparatus 20A may apply a multiple to the number of segments of the LED tape based on a proportion of the overall segments that are segments 302B,308B with reference paths 306. In some embodiments, the indication of the number of segments of the LED tape 15 does not change and may, for example, comprise: a computed value of the current I flowing through the reference elements in the LED tape 15, a sensed voltage output from the current sense module 30, a digital representation of the sensed voltage output from the ADC 25, or another value that can be used to associate with the number of reference paths 306 that are in parallel within the LED tape 15. In this case, the control apparatus 20A may use information on the proportion of the overall segments that are segments 302B,308B with reference paths 306 when using the indication of number of segments of the LED tape 15.

In some embodiments, at step 512, the control apparatus 20A is further configured to determine an electrical setting of the LEDs 305 in the LED tape 15 based on the indication of the number N of connected segments 302. Step 512 is similar to step 408 described with reference to FIG. 4A. By way of example, not intended to be limiting, an electrical setting may include a maximum operating current of the LEDs 305 or a programmed current of the LEDs 305. To determine the electrical setting, the control apparatus 20A may access a database comprising a plurality of records, each record indicating an electrical setting to be applied. The database may comprise a look-up table or a set of formulas to determine the appropriate electrical setting. By way of example, a look-up table may associate a list of potential indications of the number of segments 302 of the LED tape 15 to a list of corresponding electrical settings for the LEDs 305. In one particular example, a number of bits output from the ADC 25 may be an indication of the current flowing through the reference elements within the LED tape 15 and therefore may be an indication of the number of segments 302 of the LED tape 15 when combined with an indication of the predetermined voltage used to determine the indication of the number of segments 302 of the LED tape 15. In this case, the look-up table may comprise a list of predetermined voltages, or indications of predetermined voltages, that may be applied across the positive voltage rail 45 and the LD rail 43, a corresponding list of number of bits output from the ADC 25 for the different predetermined voltages and a list of electrical settings for the LEDs 305 that are linked to a particular predetermined voltage being applied across the positive voltage rail 45 and the LD rail 43 and a particular number of bits output from the ADC 25.

In other embodiments, the control apparatus 20A may access a database that includes a look-up table that associates a list of potential indications of the number of segments 302 of the LED tape 15 to a number of segments 302 of the LED tape 15. In this case, the computing apparatus 20A can use the look-up table to determine a number of segments 302 of the LED tape 15 based on the indications, and calculate an electrical setting for the LEDs 305 using the determined number of segments 302. For example, the computing apparatus 20A may multiply the number of segments 302 by a maximum current per segment or a desired current per segment in order to determine a maximum current to apply to the LEDs 305 in the LED tape 15 or to determine a desired programmed current to apply to the LEDs 305 in the LED tape 15. The determining of an electrical setting for the LEDs 305 using the indication of the number of segments 302 of the LED tape 15 can further be implemented in other manners using look-up tables of various implementation and/or computing an electrical setting from the indication of the number of segments 302 or from the output of a look-up table using the indication of the number of segments. The actual implementation of the control apparatus 20A determining the electrical setting for the LEDs 305 should not limit the scope of the present invention.

In other embodiments as described with reference to the lighting apparatus 5D of FIG. 1D and the LED tape 15A of FIGS. 3C and 3D, in the case that the segments 308,308A,308B comprise a plurality of LED paths 304A,304B, the electrical setting may include a maximum operating current corresponding to each of the sets of LEDs 305A,305B, a programmed current for each of the sets of LEDs 305A,305B, or a calibrated mix of the different sets of LEDs 305A,305B. Similar to described above, the control apparatus 20A may use a look-up table to determine the electrical settings for the LEDs 305A,305B using the indication of the number of segments 308,308A,308B of the LED tape 15A; compute the electrical settings for the LEDs 305A,305B using the indication of the number of segments 308,308A,308B of the LED tape 15A; and/or a combination of look-up tables and computations to determine the electrical settings for the LEDs 305A,305B.

In embodiments in which the LED tape 15 of FIG. 3B or the LED tape 15A of FIG. 3D is utilized in which reference paths 306 are in a limited set of segments 302B,308B of the overall segments, the database accessed by the control apparatus 20A to determine the electrical settings for the LEDs may have records that are adjusted to compensate for the proportion of the overall segments that are segments 302B,308B with reference paths 306. In other embodiments, the control apparatus 20A may make adjustments to the determined number of segments of the LED tape 15 or the indication of the number of segments based on the proportion of the overall segments that are segments 302B,308B with reference paths 306.

In some embodiments, at step 514, the control apparatus 20A is further configured to apply the electrical setting to the LEDs 305 in the LED tape 15. Step 514 is similar to step 410 described with reference to FIG. 4A. In some cases, to apply the electrical setting to the LEDs 305, the control apparatus 20A controls the current applied to the LEDs 305 by controlling the current flowing from the positive voltage rail 45 to the return voltage rail 46. In some embodiments, the control apparatus 20A may apply a maximum current to apply across the LEDs 305 based on the electrical setting of the LEDs 305 and the control apparatus 20A may reduce the current across the LEDs 305 (and therefore dim the intensity of the LEDs 305) from the maximum current, in response to a user input. In other embodiments, the control apparatus 20A may apply a programmed current to apply across the LEDs 305 based on the electrical setting of the LEDs 305 and the control apparatus 20A may either not dim the intensity of the LEDs 305 or may reduce the intensity of the LEDs 305 using other dimming techniques as one skilled in the art would understand, such as, but not limited to, PWM dimming or a hybrid of CCR and PWM dimming.

With reference to FIG. 5B and according to an embodiment of the present disclosure, an embodiment of the lighting apparatus 5A is described, along with a method of determining an indication of a number of the connected segments 302 in the LED tape 15 as performed by the control apparatus 20A or the controller 22. The method of FIG. 5B is an alternative implementation of the method of FIG. 4B in which more than one predetermined current flowing from the positive voltage rail 45 to the LD rail 43 of the LED tape 15 may be applied. The application of different predetermined currents being applied can enable the control apparatus 20A to distinguish between different numbers of segments 302 of the LED tape which might otherwise be outside a resolution limit. For example, an ADC may have a limited resolution and be unable to distinguish between slight differences in sensed voltage across the positive voltage rail 45 and the LD rail 43 at a first predetermined current but may be able to distinguish these differences at a second predetermined current.

The method of FIG. 5B may be initiated when the lighting apparatus 5A is activated, during an initial provisioning cycle, regularly during operation, or another time as may be triggered or scheduled within the control apparatus 20A. At step 522, the control apparatus 20A applies a first predetermined current flowing from the positive voltage rail 45 to the LD rail 43. At step 522, the control apparatus 20A applies a first predetermined current flowing from the positive voltage rail 45 to the LD rail 43. The control apparatus 20A may apply the first predetermined current by measuring the current flowing between the positive voltage rail 45 and the LD rail 43 using the current sense module 30 and ADC 25 and then controlling the voltage converter 35 to achieve the desired first predetermined current. The first predetermined current will be divided among the reference paths 306 within the segments 302 of the LED tape 15 which are electrically in parallel. Once the first predetermined current has been applied at step 522, the control apparatus 20A senses the resulting voltage V between the positive voltage rail 45 and the LD rail 43 at step 524, similar to step 424 of FIG. 4B. The sensing of the resulting voltage V may be done in a variety of manners as one skilled in the art would understand. For example, the controller 22 may directly measure a voltage level on the positive voltage rail 45 and a voltage level on the LD rail 43 required to maintain the predetermined current flowing from the positive voltage rail 45 to the LD rail 43, may have another ADC that generates a digital representation of these voltage levels, and may subtract the two voltages to determine the voltage between the positive voltage rail 45 and the LD rail 43. In other cases, the controller 22 may interpolate an indication of the voltage between the positive voltage rail 45 and the LD rail 43 using the level of the signal 50 used to control the voltage converter 35 to maintain the predetermined current.

As depicted at step 526 in FIG. 5B, the control apparatus 20A then compares the sensed voltage V or the indication of the sensed voltage V to a predetermined limit for assessing the number of segments 302 of the LED tape 15 using the first predetermined current. The limit for assessing the number of segments 302 of the LED tape 15 may be as a result of limitations in the control apparatus 20A being able to distinguish between different sensed voltages based on different numbers of segments 302 of the LED tape 15, such as a resolution limitation of an ADC or a tolerance limitation in the voltage sensing elements. In other embodiments, other limitations could apply to the ability of the control apparatus 20A being able to determine differences between the number of segments 302 of the LED tape 15. If the sensed voltage V or the indication of the sensed voltage V is less than a predetermined limit for assessing the number of segments 302 of the LED tape 15 using the first predetermined current, the control apparatus 20A applies a second predetermined current, higher than the first predetermined current, flowing from the positive voltage rail 45 to the LD rail 43 at step 528. This second predetermined current will be divided among the reference paths 306 within the segments 302 of the LED tape 15 which are electrically in parallel. Once the second predetermined current has been applied at step 528, the control apparatus 20A repeats step 524 and senses the resulting voltage value V across the positive voltage rail 45 and the LD rail 43. The control apparatus 20A may then repeat step 526 and compare the sensed voltage V or the indication of the sensed voltage V to a predetermined limit for assessing the number of segments 302 of the LED tape 15 using the second predetermined current. The process of steps 526, 528 and 524 may be repeated with a plurality of different predetermined currents and a plurality of limits for assessing the number of segments 302 of the LED tape 15 using the respective predetermined currents.

If the sensed voltage V or the indication of the sensed voltage V is equal or higher than the predetermined limit for assessing the number of segments 302 of the LED tape 15 using the predetermined current at step 526, in some embodiments, the control apparatus 20A determines an indication of the number N of connected segments 302 of the LED tape 15 at step 530 based at least on the indication of the voltage value V sensed, the indication of the number N being a value related to the number of connected segments 302. Step 530 is similar to step 426 described with reference to FIG. 4B. Similar to step 426, the indication of the number N of connected segments 302 may, for example, comprise: a computed value of the voltage V between the positive voltage rail 45 and the LD rail 43, a sensed voltage between the positive voltage rail 45 and the LD rail 43, a digital representation of the sensed voltage between the positive voltage rail 45 and the LD rail 43, or another value that can be used to associate with the number of reference paths 306 that are in parallel within the LED tape 15.

In embodiments in which the LED tape 15 of FIG. 3B or the LED tape 15A of FIG. 3D is utilized in which reference paths 306 are in a limited set of segments 302B,308B of the overall segments, the control apparatus 20A may apply a multiple to the number of segments of the LED tape based on a proportion of the overall segments that are segments 302B,308B with reference paths 306. In some embodiments, the indication of the number of segments of the LED tape 15 does not change and may, for example, comprise: a computed value of the current I flowing through the reference elements in the LED tape 15, a sensed voltage output from the current sense module 30, a digital representation of the sensed voltage output from the ADC 25, or another value that can be used to associate with the number of reference paths 306 that are in parallel within the LED tape 15. In this case, the control apparatus 20A may use information on the proportion of the overall segments that are segments 302B,308B with reference paths 306 when using the indication of number of segments of the LED tape 15.

In some embodiments, at step 532, the control apparatus 20A is further configured to determine an electrical setting of the LEDs 305 in the LED tape 15 based on the indication of the number N of connected segments 302. Step 532 is similar to step 428 described with reference to FIG. 4B. By way of example, not intended to be limiting, an electrical setting may include a maximum operating current of the LEDs 305 or a programmed current of the LEDs 305. To determine the electrical setting, the control apparatus 20A may access a database comprising a plurality of records, each record indicating an electrical setting to be applied. The database may comprise a look-up table or a set of formulas to determine the appropriate electrical setting. By way of example, a look-up table may associate a list of potential indications of the number of segments 302 of the LED tape 15 to a list of corresponding electrical settings for the LEDs 305. In one particular example, a number of bits output from an ADC may be an indication of the voltage at the LD rail 43 and therefore may be an indication of the number of segments 302 of the LED tape 15 when combined with an indication of the predetermined current used to determine the indication of the number of segments 302 of the LED tape 15. In this case, the look-up table may comprise a list of predetermined currents, or indications of predetermined currents, that may be applied to flow from the positive voltage rail 45 to the LD rail 43, a corresponding list of number of bits output from the ADC for the different predetermined currents, and a list of electrical settings for the LEDs 305 that are linked to a particular predetermined current being applied to flow from the positive voltage rail 45 to the LD rail 43 and a particular number of bits output from the ADC.

In other embodiments, the control apparatus 20A may access a database that includes a look-up table that associates a list of potential indications of the number of segments 302 of the LED tape 15 to a number of segments 302 of the LED tape 15. In this case, the computing apparatus 20A can use the look-up table to determine a number of segments 302 of the LED tape 15 based on the indications, and calculate an electrical setting for the LEDs 305 using the determined number of segments 302. For example, the computing apparatus 20A may multiply the number of segments 302 by a maximum current per segment or a desired current per segment in order to determine a maximum current to apply to the LEDs 305 in the LED tape 15 or to determine a desired programmed current to apply to the LEDs 305 in the LED tape 15. The determining of an electrical setting for the LEDs 305 using the indication of the number of segments 302 of the LED tape 15 can further be implemented in other manners using look-up tables of various implementation and/or computing an electrical setting from the indication of the number of segments 302 or from the output of a look-up table using the indication of the number of segments. The actual implementation of the control apparatus 20A determining the electrical setting for the LEDs 305 should not limit the scope of the present invention.

In other embodiments as described with reference to the lighting apparatus 5D of FIG. 1D and the LED tape 15A of FIGS. 3C and 3D, in the case that the segments 308,308A,308B comprise a plurality of LED paths 304A,304B, the electrical setting may include a maximum operating current corresponding to each of the sets of LEDs 305A,305B, a programmed current for each of the sets of LEDs 305A,305B, or a calibrated mix of the different sets of LEDs 305A,305B. Similar to described above, the control apparatus 20A may use a look-up table to determine the electrical settings for the LEDs 305A,305B using the indication of the number of segments 308,308A,308B of the LED tape 15A; compute the electrical settings for the LEDs 305A,305B using the indication of the number of segments 308,308A,308B of the LED tape 15A; and/or a combination of look-up tables and computations to determine the electrical settings for the LEDs 305A,305B.

In embodiments in which the LED tape 15 of FIG. 3B or the LED tape 15A of FIG. 3D is utilized in which reference paths 306 are in a limited set of segments 302B,308B of the overall segments, the database accessed by the control apparatus 20A to determine the electrical settings for the LEDs may have records that are adjusted to compensate for the proportion of the overall segments that are segments 302B,308B with reference paths 306. In other embodiments, the control apparatus 20A may make adjustments to the determined number of segments of the LED tape 15 or the indication of the number of segments based on the proportion of the overall segments that are segments 302B,308B with reference paths 306.

In some embodiments, at step 534, the control apparatus 20A is further configured to apply the electrical setting to the LEDs 305 in the LED tape 15. Step 534 is similar to step 430 described with reference to FIG. 4B. In some cases, to apply the electrical setting to the LEDs 305, the control apparatus 20A controls the current applied to the LEDs 305 by controlling the current flowing from the positive voltage rail 45 to the return voltage rail 46. In some embodiments, the control apparatus 20A may apply a maximum current to apply across the LEDs 305 based on the electrical setting of the LEDs 305 and the control apparatus 20A may reduce the current across the LEDs 305 (and therefore dim the intensity of the LEDs 305) from the maximum current, in response to a user input. In other embodiments, the control apparatus 20A may apply a programmed current to apply across the LEDs 305 based on the electrical setting of the LEDs 305 and the control apparatus 20A may either not dim the intensity of the LEDs 305 or may reduce the intensity of the LEDs 305 using other dimming techniques as one skilled in the art would understand, such as, but not limited to, PWM dimming or a hybrid of CCR and PWM dimming.

The following is an example implementation of the present invention using the lighting apparatus 5A of FIG. 1A and the LED tape 15 of FIG. 3A and should not be used to limit the scope of the present invention. In this example, the LED tape 15 comprises segments 302 that are 1 inch in length and the original length of the LED tape 15 comprises 192 segments as the LED tape 15 comprises a total original length of 16 feet. In this example, each of the segments 302 comprises a reference path 306 with a resistor in series between the positive voltage rail 45 and the LD rail 43 and each of the resistors are in parallel with the other resistors in the other segments. During installation of the LED tape 15, a user may cut the LED tape 15 between two of the segments 302, thus shortening the LED tape 15 to a length that may be desirable for the installation. The cutting of the LED tape 15 may result in an unknown number of segments 302 remaining in the LED tape 15 that is being used and therefore uncertainty of the electrical settings to apply to the LEDs 305 within the remaining portion of the LED tape 15. In this implementation, the control apparatus 20A applies a predetermined voltage between the positive voltage rail 45 and the LD rail 43; determines an indication of a resulting current flowing from the positive voltage rail 45 and the LD rail 43, which may be a digital representation of a signal from the current sense module 30; determines an electrical setting such as a maximum current to apply to the LEDs 305 based on the indication of the resulting current flowing from the positive voltage rail 45 and the LD rail 43, which may be done by accessing a database that links indications of currents to electrical settings such as maximum currents; and applies current to the LEDs 305 of the LED tape 15 with the electrical settings such as the maximum current as determined. This process of setting electrical settings, such as maximum currents, may be done at start-up of the lighting apparatus 5A, periodically or when triggered by an internal or external signal.

The database in this example implementation could be a simple look-up table with the output from the ADC 25 indicating a specific number of segments 302 remaining in the LED tape 15 and/or a specific maximum desired current to be applied to the LEDs 305 within the LED tape 15. In the case that the look-up table indicated the specific number of segments 302 remaining in the LED tape 15, the control apparatus 20A may multiply the specific number of segments 302 remaining in the LED tape 15 by a desired maximum current per segment in order to determine a specific maximum desired current to be applied to the LEDs 305 within the LED tape 15. In some embodiments, in which the ADC outputs may exceed a maximum limit, the look-up table may also include an indication of the predetermined voltages that are applied as the control apparatus 20A may apply different predetermined voltages as required as described with the method of FIG. 5A.

In the embodiments described, the reference elements are resistors and the methods for determining the number of segments within the LED tape leverage Ohm's Law to determine the number of resistors in parallel within the LED tape in order to extrapolate to the number of segments within the LED tape. In other embodiments, other reference elements may be used and alternative techniques for determining the number of segments within the LED tape are required. In one embodiment, the reference elements within the reference paths 306 of each of the segments of the LED tape comprise a capacitor with a similar level of capacitance and a total capacitance between the positive voltage rail 45 and the LD rail 43 can be determined in order to determine an indication of the number of capacitors in parallel and therefore the number of segments within the LED tape. Total capacitance with capacitors with similar levels of capacitance in parallel is equal to N*C, where N is the number of capacitors in parallel (and therefore the number of segments in the LED tape) and C is the level of capacitance of each capacitor. There are a number of implementations for detecting capacitance that could be implemented to determine the total capacitance between the positive voltage rail 45 and the LD rail 43 that one skilled in the art would understand.

In another embodiment, the reference elements within the reference paths 306 of each of the segments of the LED tape comprise an inductor with a similar level of inductance and a total inductance between the positive voltage rail 45 and the LD rail 43 can be determined in order to determine an indication of the number of inductors in parallel and therefore the number of segments within the LED tape. Total inductance with inductors with similar levels of inductance in parallel is equal to L/N, where N is the number of inductors in parallel (and therefore the number of segments in the LED tape) and L is the level of inductance of each inductor. There are a number of implementations for detecting inductance that could be implemented to determine the total inductance between the positive voltage rail 45 and the LD rail 43 that one skilled in the art would understand.

In yet another embodiment, the control apparatus 20A may be operable to use the LEDs 305 within the LED paths 304 of the LED tape 15 as a reference element and therefore the LED path 304 could operate as a reference path 306. In this embodiment, the control apparatus 20A may apply a predetermined voltage between the positive voltage rail 45 and the return voltage rail 46 which will apply the predetermined voltage across the LED paths 304. The predetermined voltage would need to be set to be sufficient to turn on the LEDs 305, no matter how many LED paths 304 are in the LED tape 15 and low enough to ensure that the LEDs 305 are not damaged, no matter how many LED paths are in the LED tape 15. The control apparatus could then detect a resulting current flowing from the positive voltage rail 45 to the return voltage rail 46 using a current sense module similar to the current sense module 30 but connected to the return voltage rail 46 and an ADC similar to the ADC 25 but connected to the current sense module connected to the return voltage rail 46. In this case, the control apparatus 20A may be able to divide the sensed current by an expected current draw per LED path 304 at the predetermined voltage. The result of this division can be an approximation of the number of LED paths 304 that are in parallel and therefore the number of segments that are in the LED tape 15. In a modified implementation, the control apparatus 20A may control the current flowing from the positive voltage rail 45 to the return voltage rail 46 and initially start with a low current and incrementally increase the current flowing from the positive voltage rail 45 to the return voltage rail 46 until a predetermined voltage between the positive voltage rail 45 and the return voltage rail 46 is achieved. The current that was applied that achieved the predetermined voltage could then be divided by the expected current draw per LED path 304 at the predetermined voltage. Similar to the other embodiment, the result of this division can be an approximation of the number of LED paths 304 that are in parallel and therefore the number of segments that are in the LED tape 15.

One issue with embodiments using the LEDs 305 as reference elements is that there may be inconsistency in the current drawn by each LED path due to variability of the forward voltages of the LEDs 305. Binning of the LEDs 305 tightly for forward voltage at a particular current could improve this inconsistency. In some embodiments, a resistor is implemented in series with the LEDs 305 in each of the LED paths 304 to improve consistency of the current drawn by each LED path. Another issue with these embodiments is that thermal conditions on the LEDs 305 can affect the forward voltage of the LEDs 305 and therefore the current draw per LED path 304. Measuring a temperature proximate to one or more of the LEDs 305 could allow for a calibration adjustment based on the thermal conditions to be applied but this implementation would be complex and prone to potential differences in thermal conditions across the LEDs 305, especially LEDs 305 located closer to the power source of the LED tape.

In some embodiments, to address the inaccuracies of using LEDs as reference elements, the control apparatus 20D of FIG. 1D could attempt to determine the number of LED paths in parallel in each of a plurality of different LED channels in the LED tape 15A. In this case, the control apparatus 20D may determine a first current flowing from the positive voltage rail 45 to the channel 1 return rail 47 with a first predetermined voltage between the positive voltage rail 45 and the channel 1 return rail 47; determine a first indication of a number of channel 1 LED paths in the LED tape 15A by dividing the first current by an expected draw per channel 1 LED path connected between the positive voltage rail 45 and the channel 1 return rail 47; determine a second current flowing from the positive voltage rail 45 to the channel 2 return rail 48 with a second predetermined voltage between the positive voltage rail 45 and the channel 2 return rail 48 (which may be the same as the first predetermined voltage or different); and determine a second indication of a number of channel 2 LED paths in the LED tape 15A by dividing the second current by an expected draw per channel 2 LED path connected between the positive voltage rail 45 and the channel 2 return rail 48. The control apparatus 20A may continue this process for further LED channels to determine a plurality of indications of the number of LED paths of each channel in the LED tape 15A, which may be similar or may be different from each other. The control apparatus 20A may then use the plurality of indication of the number of LED paths of each channel in the LED tape 15A to generate a prediction of the number of segments 308 within the LED tape 15A. To generate the prediction, the control apparatus 20A may take an average value or median value of the indications of the number of LED paths of each channel or may do an alternative processing of the indications based on an assessment of confidence in each result. The prediction of the number of segments 308 within the LED tape 15A may then be used to determine electrical settings to be applied to the plurality of channels of LEDs, such as maximum currents or desired programmed currents for each of the plurality of LED channels.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated disclosure, which is not to be limited to the specific embodiment disclosed.

1. A lighting apparatus comprising:
an LED tape comprising a plurality of connected segments, each of the segments comprising an LED path comprising at least one LED coupled in parallel with LEDs in other of the segments; wherein each of a first set of the segments further comprise a reference path comprising a reference element coupled in parallel with reference elements in other of the segments of the first set; and
a control apparatus operable to determine an indication of a number of the segments in the LED tape using the reference elements coupled in parallel within the first set of the segments.

2. The lighting apparatus of claim 1, wherein the control apparatus is operable to determine an electrical setting for the LEDs within the segments of the LED tape based on the indication of the number of segments.

3. The lighting apparatus of claim 2, wherein the electrical setting to be applied to the LEDs comprises a maximum current to be applied to the LEDs within the segments of the LED tape based on the indication of the number of segments of the LED tape.

4. The lighting apparatus of claim 3, wherein, to determine the electrical setting for the LEDs within the segments of the LED tape, the control apparatus is operable to access a database comprising a plurality of records, each record indicating a specific maximum current to be applied to the LEDs within the segments of the LED tape based on the indication of the number of segments of the LED tape.

5. The lighting apparatus of claim 3, wherein the control apparatus is incorporated within an LED driver that is operable to apply a current less than or equal to the maximum current to be applied to the LEDs within the segments of the LED tape.

6. The lighting apparatus of claim 2, wherein the LED path of each of the segments is a first LED path and the at least one LED in the first LED path comprises at least one first LED coupled in parallel with first LEDs in other of the segments; wherein each of the segments further comprises a second LED path comprising at least one second LED coupled in parallel with second LEDs in other of the segments; and wherein the electrical setting to be applied to the LEDs comprises a first maximum current to be applied to the first LEDs within the segments of the LED tape based on the indication of the number of segments of the LED tape and a second maximum current to be applied to the second LEDs within the segments of the LED tape based on the indication of the number of segments of the LED tape.

7. The lighting apparatus of claim 1, wherein the LED tape is cuttable to a plurality of different numbers of segments.

8. The lighting apparatus of claim 1, wherein, to determine the indication of the number of segments in the LED tape, the control apparatus is operable to determine an indication of a number of the reference elements coupled in parallel within the first set of the segments of the LED tape.

9. The lighting apparatus of claim 8, wherein the first set of the segments comprises all of the segments of the LED tape; whereby the indication of the number of reference elements in parallel within the LED tape is the indication of the number of segments in the LED tape.

10. The lighting apparatus of claim 8, wherein the first set of the segments comprises a plurality of reference segments spread out at predetermined intervals along the length of the LED tape; whereby the indication of the number of reference elements in parallel within the LED tape is an indication of a number of reference segments in the LED tape and, as the plurality of reference segments are spread out at the predetermined intervals along the length of the LED tape, the indication of the number of reference elements in parallel within the LED tape is further the indication of the number of segments in the LED tape.

11. The lighting apparatus of claim 1, wherein the reference element within the reference path of each segment of the first set comprises a resistor and, to determine the indication of the number of segments in the LED tape, the control apparatus is operable to determine an indication of a number of the resistors coupled in parallel within the first set of the segments of the LED tape.

12. The lighting apparatus of claim 11, wherein, to determine the indication of the number of resistors coupled in parallel within the first set of the segments, the control apparatus is operable to apply a predetermined voltage to the resistors coupled in parallel within the first set of the segments and to detect an indication of a resulting current flowing through the resistors coupled in parallel within the first set of the segments.

13. The lighting apparatus of claim 11, wherein, to determine the indication of the number of resistors coupled in parallel within the first set of the segments, the control apparatus is operable to apply a first predetermined voltage to the resistors coupled in parallel within the first set of the segments and to detect a first indication of a resulting current flowing through the resistors coupled in parallel within the first set of the segments; and, if the first indication of the resulting current flowing through the resistors is greater than a first limit, to apply a second predetermined voltage to the resistors coupled in parallel within the first set of the segments and to detect a second indication of a resulting current flowing through the resistors coupled in parallel within the first set of the segments; wherein the second predetermined voltage is less than the first predetermined voltage.

14. The lighting apparatus of claim 11, wherein, to determine the indication of the number of resistors coupled in parallel within the first set of the segments, the control apparatus is operable to apply a predetermined current to the resistors coupled in parallel within the first set of the segments and to detect an indication of a resulting voltage across the resistors coupled in parallel within the first set of the segments.

15. The lighting apparatus of claim 11, wherein, to determine the indication of the number of resistors coupled in parallel within the first set of the segments, the control apparatus is operable to apply a first predetermined current to the resistors coupled in parallel within the first set of the segments and to detect a first indication of a resulting voltage across the resistors coupled in parallel within the first set of the segments; and, if the first indication of the resulting voltage across the resistors is less than a first limit, to apply a second predetermined current to the resistors coupled in parallel within the first set of the segments and to detect a second indication of a resulting voltage across the resistors; wherein the second predetermined current is greater than the first predetermined current.

16. A control apparatus operable to connect to an LED tape comprising a plurality of connected segments, each of the segments comprising an LED path comprising at least one LED coupled in parallel with LEDs in other of the segments; wherein each of a first set of the segments further comprise a reference path comprising a reference element coupled in parallel with reference elements in other of the segments of the first set; the control apparatus comprising:
an interface operable to connect to the reference paths in each of the first set of the segments of the LED tape; and
a controller operable to determine an indication of a number of the segments in the LED tape using the reference elements coupled in parallel within the first set of the segments.

17. The control apparatus of claim 16, wherein the controller is operable to determine an electrical setting for the LEDs within the segments of the LED tape based on the indication of the number of segments.

18. The control apparatus of claim 17, wherein the electrical setting to be applied to the LEDs comprises a maximum current to be applied to the LEDs within the segments of the LED tape based on the indication of the number of segments of the LED tape.

19. The control apparatus of claim 18, wherein, to determine the electrical setting for the LEDs within the segments of the LED tape, the controller is operable to access a database comprising a plurality of records, each record indicating a specific maximum current to be applied to the LEDs within the segments of the LED tape based on the indication of the number of segments of the LED tape.

20. An LED driver comprising the control apparatus of claim 18, wherein the interface is operable to connect to the LED paths in each of the segments of the LED tape; and wherein the LED driver is operable to apply a current less than or equal to the maximum current to be applied to the LED paths within the segments of the LED tape.

21. The control apparatus of claim 17, wherein the LED path of each of the segments is a first LED path and the at least one LED in the first LED path comprises at least one first LED coupled in parallel with first LEDs in other of the segments; wherein each of the segments further comprises a second LED path comprising at least one second LED coupled in parallel with second LEDs in other of the segments; and wherein the electrical setting to be applied to the LEDs comprises a first maximum current to be applied to the first LEDs within the segments of the LED tape based on the indication of the number of segments of the LED tape and a second maximum current to be applied to the second LEDs within the segments of the LED tape based on the indication of the number of segments of the LED tape.

22. The control apparatus of claim 16, wherein, to determine the indication of the number of segments in the LED tape, the controller is operable to determine an indication of a number of the reference elements coupled in parallel within the first set of the segments of the LED tape.

23. The control apparatus of claim 16, wherein the reference element within the reference path of each segment of the first set comprises a resistor and, to determine the indication of the number of segments in the LED tape, the controller is operable to determine an indication of a number of the resistors coupled in parallel within the first set of the segments of the LED tape.

24. The control apparatus of claim 23, wherein, to determine the indication of the number of resistors coupled in parallel within the first set of the segments, the controller is operable to apply a predetermined voltage to the resistors coupled in parallel within the first set of the segments and to detect an indication of a resulting current flowing through the resistors coupled in parallel within the first set of the segments.

25. The control apparatus of claim 23, wherein, to determine the indication of the number of resistors coupled in parallel within the first set of the segments, the controller is operable to apply a first predetermined voltage to the resistors coupled in parallel within the first set of the segments and to detect a first indication of a resulting current flowing through the resistors coupled in parallel within the first set of the segments; and, if the first indication of the resulting current flowing through the resistors is greater than a first limit, to apply a second predetermined voltage to the resistors coupled in parallel within the first set of the segments and to detect a second indication of a resulting current flowing through the resistors coupled in parallel within the first set of the segments; wherein the second predetermined voltage is less than the first predetermined voltage.

26. The control apparatus of claim 23, wherein, to determine the indication of the number of resistors coupled in parallel within the first set of the segments, the controller is operable to apply a predetermined current to the resistors coupled in parallel within the first set of the segments and to detect an indication of a resulting voltage across the resistors coupled in parallel within the first set of the segments.

27. The control apparatus of claim 23, wherein, to determine the indication of the number of resistors coupled in parallel within the first set of the segments, the controller is operable to apply a first predetermined current to the resistors coupled in parallel within the first set of the segments and to detect a first indication of a resulting voltage across the resistors coupled in parallel within the first set of the segments; and, if the first indication of the resulting voltage across the resistors is less than a first limit, to apply a second predetermined current to the resistors coupled in parallel within the first set of the segments and to detect a second indication of a resulting voltage across the resistors; wherein the second predetermined current is greater than the first predetermined current.

28. An LED tape comprising:
a plurality of connected segments, each of the segments comprising an LED path comprising at least one LED coupled in parallel with LEDs in other of the segments;
wherein each of a first set of the segments further comprise a reference path comprising a reference element coupled in parallel with reference elements in other of the segments of the first set; whereby an indication of the number of reference elements coupled in parallel is an indication of the number of the segments in the LED tape.

29. The LED tape of claim 28, wherein the LED tape is cuttable to a plurality of numbers of segments.

30. The LED tape of claim 28, wherein the first set of the segments comprises all of the segments of the LED tape.

31. The LED tape of claim 28, wherein the first set of the segments comprises a plurality of reference segments spread out at predetermined intervals along the length of the LED tape.

32. The LED tape of claim 26, wherein the reference element within the reference path of each segment of the first set comprises a resistor.
